(19) United States
(12) Patent Application Publication
(10) Pub. No.: US 2025/0056668 A1
(43) Pub. Date: Feb. 13, 2025

(54) SUPPORT OF MULTICAST AND BROADCAST SYSTEM SERVICES FROM PUBLIC LAND MOBILE NETWORK BY ROAMING USER EQUIPMENT USING INDIVIDUAL DELIVERY

(71) Applicant: Nokia Technologies Oy, Espoo (FI)

(72) Inventors: Mohamed Amin NASSAR, Munich (DE); Philippe GODIN, Massy (FR); Bruno LANDAIS, Lannion (FR); Horst Thomas BELLING, Munich (DE); Ugur Baran ELMALI, Munich (DE); Abdelaali CHAOUB, Massy (FR)

(21) Appl. No.: 18/775,987

(22) Filed: Jul. 17, 2024

Related U.S. Application Data
(60) Provisional application No. 63/532,016, filed on Aug. 10, 2023.

(51) Int. Cl. H04W 76/40; H04W 28/02; H04W 84/04

(52) U.S. Cl. CPC H04W 76/40; H04W 28/0268; H04W 84/042

(57) ABSTRACT

A H-SMF receives, from a V-SMF in a VPLMN, a join request originating from a UE roaming in the VPLMN to join a multicast multicast and broadcast services (MBS) session, and determines whether the UE is authorized to join the multicast MBS session based upon a local configuration in a home public land mobile network, information received from an application function during establishment of the multicast MBS session, and/or user subscription data received from a user data manager. The H-SMF at least one of: transmits to the V-SMF, if the UE is authorized, an acceptance response configured to establish at least one unicast QoS flow corresponding to multicast QoS flow information received from a H-MB-SMF, or, if the UE is not authorized, a rejection response comprising error cause information indicating that the UE is not authorized to join while roaming.

### TECHNICAL FIELD

Some example embodiments may generally relate to mobile or wireless telecommunication systems, such as 3^{rd} Generation Partnership Project (3GPP) Long Term Evolution (LTE), 5th generation (5G) radio access technology (RAT), new radio (NR) access technology, 6th generation (6G), and/or other communications systems. For example, certain example embodiments may relate to systems and/or methods for supporting multicast services.

### BACKGROUND

Examples of mobile or wireless telecommunication systems may include radio frequency (RF) 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine-type communication (mMTC). NR is expected to deliver extreme broadband, ultra-robust, low-latency connectivity, and massive networking to support the Internet of Things (IoT). The next generation radio access network (NG-RAN) represents the radio access network (RAN) for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-cNB) when built on E-UTRA radio.

### SUMMARY

In accordance with some example embodiments, a method may include receiving, by a home session management function (H-SMF), from a visited session management function (V-SMF) in a visited public land mobile network (VPLMN), a join request originating from a user equipment (UE) roaming in the VPLMN to join a multicast multicast and broadcast services (MBS) session. The method may further include determining, by the H-SMF, whether the UE is authorized to join the multicast MBS session. The determining is based upon at least one of a local configuration in a home public land mobile network, information received from an application function during establishment of the multicast MBS session, or user subscription data received from a user data manager. The method may further include performing at least one of based on determining that the UE is authorized to join the multicast MBS session, transmitting, by the H-SMF, to the V-SMF, an acceptance response configured to establish at least one unicast quality of service (QOS) flow corresponding to multicast QoS flow information received from a home multicast/broadcast session management function (H-MB-SMF), or based on determining that the UE is not authorized to join the multicast MBS session, transmitting, by the H-SMF, to the V-SMF, a rejection response comprising error cause information indicating that the UE is not authorized to join the multicast MBS session while roaming.

In accordance with certain example embodiments, an apparatus may include means for receiving from a visited session management function (V-SMF) in a visited public land mobile network (VPLMN), a join request originating from a user equipment (UE) roaming in the VPLMN to join a multicast multicast and broadcast services (MBS) session. The apparatus may further include means for determining whether the UE is authorized to join the multicast MBS session. The determining is based upon at least one of a local configuration in a home public land mobile network, information received from an application function during establishment of the multicast MBS session, or user subscription data received from a user data manager. The apparatus may further include means for performing at least one of based on determining that the UE is authorized to join the multicast MBS session, transmitting, to the V-SMF, an acceptance response configured to establish at least one unicast quality of service (QOS) flow corresponding to multicast QoS flow information received from a home multicast/broadcast session management function (H-MB-SMF), or based on determining that the UE is not authorized to join the multicast MBS session, transmitting, to the V-SMF, a rejection response comprising error cause information indicating that the UE is not authorized to join the multicast MBS session while roaming.

In accordance with various example embodiments, a non-transitory computer readable medium may include program instructions that, when executed by an apparatus, cause the apparatus to perform at least a method. The method may include receiving from a visited session management function (V-SMF) in a visited public land mobile network (VPLMN), a join request originating from a user equipment (UE) roaming in the VPLMN to join a multicast multicast and broadcast services (MBS) session. The method may further include determining whether the UE is authorized to join the multicast MBS session. The determining is based upon at least one of a local configuration in a home public land mobile network, information received from an application function during establishment of the multicast MBS session, or user subscription data received from a user data manager. The method may further include performing at least one of based on determining that the UE is authorized to join the multicast MBS session, transmitting, to the V-SMF, an acceptance response configured to establish at least one unicast quality of service (QOS) flow corresponding to multicast QoS flow information received from a home multicast/broadcast session management function (H-MB-SMF), or based on determining that the UE is not authorized to join the multicast MBS session, transmitting, to the V-SMF, a rejection response comprising error cause information indicating that the UE is not authorized to join the multicast MBS session while roaming.

In accordance with some example embodiments, a computer program product may perform a method. The method may include receiving from a visited session management function (V-SMF) in a visited public land mobile network (VPLMN), a join request originating from a user equipment (UE) roaming in the VPLMN to join a multicast multicast and broadcast services (MBS) session. The method may further include determining whether the UE is authorized to join the multicast MBS session. The determining is based upon at least one of a local configuration in a home public land mobile network, information received from an application function during establishment of the multicast MBS session, or user subscription data received from a user data manager. The method may further include performing at least one of based on determining that the UE is authorized to join the multicast MBS session, transmitting, to the V-SMF, an acceptance response configured to establish at least one unicast quality of service (QOS) flow corresponding to multicast QoS flow information received from a home multicast/broadcast session management function (H-MB-SMF), or based on determining that the UE is not authorized to join the multicast MBS session, transmitting, to the V-SMF, a rejection response comprising error cause information indicating that the UE is not authorized to join the multicast MBS session while roaming.

In accordance with certain example embodiments, an apparatus may include at least one processor and at least one memory storing instructions that, when executed by the at least one processor, cause the apparatus at least to receive from a visited session management function (V-SMF) in a visited public land mobile network (VPLMN), a join request originating from a user equipment (UE) roaming in the VPLMN to join a multicast multicast and broadcast services (MBS) session. The at least one memory and instructions, when executed by the at least one processor, may further cause the apparatus at least to determine whether the UE is authorized to join the multicast MBS session. The determining is based upon at least one of a local configuration in a home public land mobile network, information received from an application function during establishment of the multicast MBS session, or user subscription data received from a user data manager. The at least one memory and instructions, when executed by the at least one processor, may further cause the apparatus at least to perform at least one of based on determining that the UE is authorized to join the multicast MBS session, transmitting, to the V-SMF, an acceptance response configured to establish at least one unicast quality of service (QOS) flow corresponding to multicast QoS flow information received from a home multicast/broadcast session management function (H-MB-SMF), or based on determining that the UE is not authorized to join the multicast MBS session, transmitting, to the V-SMF, a rejection response comprising error cause information indicating that the UE is not authorized to join the multicast MBS session while roaming.

In accordance with various example embodiments, an apparatus may include receiving circuitry configured to perform receiving from a visited session management function (V-SMF) in a visited public land mobile network (VPLMN), a join request originating from a user equipment (UE) roaming in the VPLMN to join a multicast multicast and broadcast services (MBS) session. The apparatus may further include determining circuitry configured to perform determining whether the UE is authorized to join the multicast MBS session. The determining is based upon at least one of a local configuration in a home public land mobile network, information received from an application function during establishment of the multicast MBS session, or user subscription data received from a user data manager. The apparatus may further include transmitting circuitry configured to perform at least one of based on determining that the UE is authorized to join the multicast MBS session, transmitting, to the V-SMF, an acceptance response configured to establish at least one unicast quality of service (QOS) flow corresponding to multicast QoS flow information received from a home multicast/broadcast session management function (H-MB-SMF), or based on determining that the UE is not authorized to join the multicast MBS session, transmitting, to the V-SMF, a rejection response comprising error cause information indicating that the UE is not authorized to join the multicast MBS session while roaming.

In accordance with some example embodiments, a method may include receiving, by a visited session management function (V-SMF), from a UE, a join request requesting that the UE joins a multicast MBS session. The method may further include determining, by the V-SMF, that the PDU session associated with the join request is a home routed PDU session towards an H-SMF. The method may further include transmitting, based on the determination, the join request to the identified H-SMF. The method may further include receiving, by the V-SMF, at least one of an acceptance response to the join request comprising a request to establish at least one unicast QoS flow, or a rejection response. The method may further include transmitting, by the V-SMF, the response to the join request towards the UE.

In accordance with certain example embodiments, an apparatus may include means for receiving, from a UE, a join request requesting that the UE joins a multicast MBS session. The apparatus may further include means for determining that a protocol data unit (PDU) session associated with the join request is a home routed PDU session towards a home session management function (H-SMF). The apparatus may further include means for transmitting, based on the determination, the join request to the identified H-SMF. The apparatus may further include means for receiving at least one of an acceptance response to the join request comprising a request to establish at least one unicast QoS flow, or a rejection response. The apparatus may further include means for transmitting the response to the join request towards the UE.

In accordance with various example embodiments, a non-transitory computer readable medium may include program instructions that, when executed by an apparatus, cause the apparatus to perform at least a method. The method may include receiving, from a UE, a join request requesting that the UE joins a multicast MBS session. The method may further include determining that a protocol data unit (PDU) session associated with the join request is a home routed PDU session towards a home session management function (H-SMF). The method may further include transmitting, based on the determination, the join request to the identified H-SMF. The method may further include receiving at least one of an acceptance response to the join request comprising a request to establish at least one unicast QoS flow, or a rejection response. The method may further include transmitting the response to the join request towards the UE.

In accordance with some example embodiments, a computer program product may perform a method. The method may include receiving, from a UE, a join request requesting that the UE joins a multicast MBS session. The method may further include determining that a protocol data unit (PDU) session associated with the join request is a home routed PDU session towards a home session management function (H-SMF). The method may further include transmitting, based on the determination, the join request to the identified H-SMF. The method may further include receiving at least one of an acceptance response to the join request comprising a request to establish at least one unicast QoS flow, or a rejection response. The method may further include transmitting the response to the join request towards the UE.

In accordance with certain example embodiments, an apparatus may include at least one processor and at least one memory storing instructions that, when executed by the at least one processor, cause the apparatus at least to receive, from a UE, a join request requesting that the UE joins a multicast MBS session. The at least one memory and instructions, when executed by the at least one processor, may further cause the apparatus at least to determine that a protocol data unit (PDU) session associated with the join request is a home routed PDU session towards a home session management function (H-SMF). The at least one memory and instructions, when executed by the at least one processor, may further cause the apparatus at least to transmit, based on the determination, the join request to the identified H-SMF. The at least one memory and instructions, when executed by the at least one processor, may further cause the apparatus at least to receive at least one of an acceptance response to the join request comprising a request to establish at least one unicast QoS flow, or a rejection response. The at least one memory and instructions, when executed by the at least one processor, may further cause the apparatus at least to transmit the response to the join request towards the UE.

In accordance with various example embodiments, an apparatus may include receiving circuitry configured to perform receiving, from a UE, a join request requesting that the UE joins a multicast MBS session. The apparatus may further include determining circuitry configured to perform determining that a protocol data unit (PDU) session associated with the join request is a home routed PDU session towards a home session management function (H-SMF). The apparatus may further include transmitting circuitry configured to perform transmitting, based on the determination, the join request to the identified H-SMF. The apparatus may further include receiving circuitry configured to perform receiving at least one of an acceptance response to the join request comprising a request to establish at least one unicast QoS flow, or a rejection response. The apparatus may further include transmitting circuitry configured to perform transmitting the response to the join request towards the UE.

In accordance with some example embodiments, a method may include receiving, by a NG RAN node, signaling to establish at least one unicast QoS flow to a UE, wherein the signaling indicates for the at least one unicast QoS flow that it relates to an MBS multicast session and at least one of an indication that shared MBS traffic delivery shall not be used, an indication that individual delivery shall be used, or an indication of a UE. The method may further include configuring at least one radio bearer to transmit the at least one unicast QoS flow to the UE. The method may further include storing the received indication for the at least one unicast QoS flow in the multicast MBS session context.

In accordance with certain example embodiments, an apparatus may include means for receiving signaling to establish at least one unicast QoS flow to a UE, wherein the signaling indicates for the at least one unicast QoS flow that it relates to an MBS multicast session and at least one of an indication that shared MBS traffic delivery shall not be used, an indication that individual delivery shall be used, or an indication of a UE. The apparatus may further include means for configuring at least one radio bearer to transmit the at least one unicast QoS flow to the UE. The apparatus may further include means for storing the received indication for the at least one unicast QoS flow in the multicast MBS session context.

In accordance with various example embodiments, a non-transitory computer readable medium may include program instructions that, when executed by an apparatus, cause the apparatus to perform at least a method. The method may include receiving signaling to establish at least one unicast QoS flow to a UE, wherein the signaling indicates for the at least one unicast QoS flow that it relates to an MBS multicast session and at least one of an indication that shared MBS traffic delivery shall not be used, an indication that individual delivery shall be used, or an indication of a UE. The method may further include configuring at least one radio bearer to transmit the at least one unicast QoS flow to the UE. The method may further include storing the received indication for the at least one unicast QoS flow in the multicast MBS session context.

In accordance with some example embodiments, a computer program product may perform a method. The method may include receiving signaling to establish at least one unicast QoS flow to a UE, wherein the signaling indicates for the at least one unicast QoS flow that it relates to an MBS multicast session and at least one of an indication that shared MBS traffic delivery shall not be used, an indication that individual delivery shall be used, or an indication of a UE. The method may further include configuring at least one radio bearer to transmit the at least one unicast QoS flow to the UE. The method may further include storing the received indication for the at least one unicast QoS flow in the multicast MBS session context.

In accordance with certain example embodiments, an apparatus may include at least one processor and at least one memory storing instructions that, when executed by the at least one processor, cause the apparatus at least to receive signaling to establish at least one unicast QoS flow to a UE, wherein the signaling indicates for the at least one unicast QoS flow that it relates to an MBS multicast session and at least one of an indication that shared MBS traffic delivery shall not be used, an indication that individual delivery shall be used, or an indication of a UE. The at least one memory and instructions, when executed by the at least one processor, may further cause the apparatus at least to configure at least one radio bearer to transmit the at least one unicast QoS flow to the UE. The at least one memory and instructions, when executed by the at least one processor, may further cause the apparatus at least to transmit the response to the join request towards the UE.

In accordance with various example embodiments, an apparatus may include receiving circuitry configured to perform receiving signaling to establish at least one unicast QoS flow to a UE, wherein the signaling indicates for the at least one unicast QoS flow that it relates to an MBS multicast session and at least one of an indication that shared MBS traffic delivery shall not be used, an indication that individual delivery shall be used, or an indication of a UE. The apparatus may further include configuring circuitry configured to perform configuring at least one radio bearer to transmit the at least one unicast QoS flow to the UE. The apparatus may further include transmitting circuitry configured to perform transmitting, by the V-SMF, the response to the join request towards the UE.

In accordance with some example embodiments, a method may include receiving, by a home session management function (H-SMF), a join request requesting a UE to join a multicast MBS session. The method may further include receiving, by the H-SMF, from a V-SMF in a first VPLMN, an N2SM container handover required transfer information element comprising multicast MBS session information of at least one MBS session that the UE has joined. The method may further include determining, by the H-SMF, whether the UE is authorized to continue receiving the multicast MBS session while the UE is roaming in the first VPLMN. The determination is based upon at least one of a local configuration in a home public land mobile network, information received from an application function during establishment of the multicast MBS session, or user subscription data received from a user data manager.

In accordance with certain example embodiments, an apparatus may include means for receiving a join request requesting a UE to join a multicast MBS session. The apparatus may further include means for receiving from a V-SMF in a first VPLMN, an N2SM container handover required transfer information element comprising multicast MBS session information of at least one MBS session that the UE has joined. The apparatus may further include means for determining whether the UE is authorized to continue receiving the multicast MBS session while the UE is roaming in the first VPLMN. The determination is based upon at least one of a local configuration in a home public land mobile network, information received from an application function during establishment of the multicast MBS session, or user subscription data received from a user data manager.

In accordance with various example embodiments, a non-transitory computer readable medium may include program instructions that, when executed by an apparatus, cause the apparatus to perform at least a method. The method may include receiving a join request requesting a UE to join a multicast MBS session. The method may further include receiving from a V-SMF in a first VPLMN, an N2SM container handover required transfer information element comprising multicast MBS session information of at least one MBS session that the UE has joined. The method may further include determining whether the UE is authorized to continue receiving the multicast MBS session while the UE is roaming in the first VPLMN. The determination is based upon at least one of a local configuration in a home public land mobile network, information received from an application function during establishment of the multicast MBS session, or user subscription data received from a user data manager.

In accordance with some example embodiments, a computer program product may perform a method. The method may include receiving a join request requesting a UE to join a multicast MBS session. The method may further include receiving from a V-SMF in a first VPLMN, an N2SM container handover required transfer information element comprising multicast MBS session information of at least one MBS session that the UE has joined. The method may further include determining whether the UE is authorized to continue receiving the multicast MBS session while the UE is roaming in the first VPLMN. The determination is based upon at least one of a local configuration in a home public land mobile network, information received from an application function during establishment of the multicast MBS session, or user subscription data received from a user data manager.

In accordance with certain example embodiments, an apparatus may include at least one processor and at least one memory storing instructions that, when executed by the at least one processor, cause the apparatus at least to receive a join request requesting a UE to join a multicast MBS session. The at least one memory and instructions, when executed by the at least one processor, may further cause the apparatus at least to receive from a V-SMF in a first VPLMN, an N2SM container handover required transfer information element comprising multicast MBS session information of at least one MBS session that the UE has joined. The at least one memory and instructions, when executed by the at least one processor, may further cause the apparatus at least to determine whether the UE is authorized to continue receiving the multicast MBS session while the UE is roaming in the first VPLMN. The determination is based upon at least one of a local configuration in a home public land mobile network, information received from an application function during establishment of the multicast MBS session, or user subscription data received from a user data manager.

In accordance with various example embodiments, an apparatus may include receiving circuitry configured to perform receiving a join request requesting a UE to join a multicast MBS session. The apparatus may further include receiving circuitry configured to perform receiving from a V-SMF in a first VPLMN, an N2SM container handover required transfer information element comprising multicast MBS session information of at least one MBS session that the UE has joined. The apparatus may further include determining circuitry configured to perform determining whether the UE is authorized to continue receiving the multicast MBS session while the UE is roaming in the first VPLMN. The determination is based upon at least one of a local configuration in a home public land mobile network, information received from an application function during establishment of the multicast MBS session, or user subscription data received from a user data manager.

In accordance with some example embodiments, a method may include receiving, by a visited session management function (V-SMF), from an AMF, a handover required transfer information element for a home routed PDU session anchored at an H-SMF. The method may further include transmitting the handover required transfer information element to the identified H-SMF. The method may further include receiving, by the V-SMF, in response to transmitting the handover required transfer information element to the H-SMF, a reply message comprising at least one of the following: a request to indicate to the UE that the UE is removed from the MBS multicast session, or a configuration to establish at least one unicast QoS flow.

In accordance with certain example embodiments, an apparatus may include means for receiving, from an AMF, a handover required transfer information element for a home routed PDU session anchored at an H-SMF. The apparatus may further include means for transmitting the handover required transfer information element to the identified H-SMF. The apparatus may further include means for receiving in response to transmitting the handover required transfer information element to the H-SMF, a reply message comprising at least one of the following: a request to indicate to the UE that the UE is removed from the MBS multicast session, or a configuration to establish at least one unicast QoS flow.

In accordance with various example embodiments, a non-transitory computer readable medium may include program instructions that, when executed by an apparatus, cause the apparatus to perform at least a method. The method may include receiving, from an AMF, a handover required transfer information element for a home routed PDU session anchored at an H-SMF. The method may further include transmitting the handover required transfer information element to the identified H-SMF. The method may further include receiving in response to transmitting the handover required transfer information element to the H-SMF, a reply message comprising at least one of the following: a request to indicate to the UE that the UE is removed from the MBS multicast session, or a configuration to establish at least one unicast QoS flow.

In accordance with some example embodiments, a computer program product may perform a method. The method may include receiving, from an AMF, a handover required transfer information element for a home routed PDU session anchored at an H-SMF. The method may further include transmitting the handover required transfer information element to the identified H-SMF. The method may further include receiving in response to transmitting the handover required transfer information element to the H-SMF, a reply message comprising at least one of the following: a request to indicate to the UE that the UE is removed from the MBS multicast session, or a configuration to establish at least one unicast QoS flow.

In accordance with certain example embodiments, an apparatus may include at least one processor and at least one memory storing instructions that, when executed by the at least one processor, cause the apparatus at least to receive, from an AMF, a handover required transfer information element for a home routed PDU session anchored at an H-SMF. The at least one memory and instructions, when executed by the at least one processor, may further cause the apparatus at least to transmit the handover required transfer information element to the identified H-SMF. The at least one memory and instructions, when executed by the at least one processor, may further cause the apparatus at least to receive in response to transmitting the handover required transfer information element to the H-SMF, a reply message comprising at least one of the following: a request to indicate to the UE that the UE is removed from the MBS multicast session, or a configuration to establish at least one unicast QoS flow.

In accordance with various example embodiments, an apparatus may include receiving circuitry configured to perform receiving, from an AMF, a handover required transfer information element for a home routed PDU session anchored at an H-SMF. The apparatus may further include transmitting circuitry configured to perform transmitting the handover required transfer information element to the identified H-SMF. The apparatus may further include receiving circuitry configured to perform receive in response to transmitting the handover required transfer information element to the H-SMF, a reply message comprising at least one of the following: a request to indicate to the UE that the UE is removed from the MBS multicast session, or a configuration to establish at least one unicast QoS flow.

In accordance with some example embodiments, a method may include transmitting, by a user equipment roaming in a VPLMN, a request to join a multicast MBS session. The method may further include receiving, by the UE, a join request reject message indication that the UE is not allowed to access the MBS session while roaming. The method may further include refraining to transmit further join request for that MBS session while roaming.

In accordance with certain example embodiments, an apparatus may include means for transmitting a request to join a multicast MBS session. The apparatus may further include means for receiving a join request reject message indication that the apparatus is not allowed to access the MBS session while roaming. The apparatus may further include means for refraining to transmit further join request for that MBS session while roaming.

In accordance with various example embodiments, a non-transitory computer readable medium may include program instructions that, when executed by an apparatus, cause the apparatus to perform at least a method. The method may include transmitting a request to join a multicast MBS session. The method may further include receiving a join request reject message indication that the apparatus is not allowed to access the MBS session while roaming. The method may further include refraining to transmit further join request for that MBS session while roaming.

In accordance with some example embodiments, a computer program product may perform a method. The method may include transmitting a request to join a multicast MBS session. The method may further include receiving a join request reject message indication that the apparatus is not allowed to access the MBS session while roaming. The method may further include refraining to transmit further join request for that MBS session while roaming.

In accordance with certain example embodiments, an apparatus may include at least one processor and at least one memory storing instructions that, when executed by the at least one processor, cause the apparatus at least to transmit a request to join a multicast MBS session. The at least one memory and instructions, when executed by the at least one processor, may further cause the apparatus at least to receive a join request reject message indication that the apparatus is not allowed to access the MBS session while roaming. The at least one memory and instructions, when executed by the at least one processor, may further cause the apparatus at least to refrain to transmit further join request for that MBS session while roaming.

In accordance with various example embodiments, an apparatus may include transmitting circuitry configured to perform transmitting a request to join a multicast MBS session. The apparatus may further include receiving circuitry configured to perform receiving a join request reject message indication that the apparatus is not allowed to access the MBS session while roaming. The apparatus may further include refraining circuitry configured to perform refrain to transmit further join request for that MBS session while roaming.

In accordance with some example embodiments, a method may include transmitting, by a user equipment roaming in a VPLMN, a request to join a multicast MBS session. The method may further include receiving, by the UE, a join request reject message indication that the UE is not allowed to access the MBS session while roaming in the VPLMN. The method may further include refraining to transmit further join request for that MBS session while roaming in the VPLMN.

In accordance with certain example embodiments, an apparatus may include means for transmitting a request to join a multicast MBS session. The apparatus may further include means for receiving a join request reject message indication that the apparatus is not allowed to access the MBS session while roaming in the VPLMN. The apparatus may further include means for refraining to transmit further join request for that MBS session while roaming in the VPLMN.

In accordance with various example embodiments, a non-transitory computer readable medium may include program instructions that, when executed by an apparatus, cause the apparatus to perform at least a method. The method may include transmitting a request to join a multicast MBS session. The method may further include receiving a join request reject message indication that the apparatus is not allowed to access the MBS session while roaming in the VPLMN. The method may further include refraining to transmit further join request for that MBS session while roaming in the VPLMN.

In accordance with some example embodiments, a computer program product may perform a method. The method may include transmitting a request to join a multicast MBS session. The method may further include receiving a join request reject message indication that the apparatus is not allowed to access the MBS session while roaming in the VPLMN. The method may further include refraining to transmit further join request for that MBS session while roaming in the VPLMN.

In accordance with certain example embodiments, an apparatus may include at least one processor and at least one memory storing instructions that, when executed by the at least one processor, cause the apparatus at least to transmit a request to join a multicast MBS session. The at least one memory and instructions, when executed by the at least one processor, may further cause the apparatus at least to receive a join request reject message indication that the apparatus is not allowed to access the MBS session while roaming in the VPLMN. The at least one memory and instructions, when executed by the at least one processor, may further cause the apparatus at least to refrain to transmit further join request for that MBS session while roaming in the VPLMN.

In accordance with various example embodiments, an apparatus may include transmitting circuitry configured to perform transmitting a request to join a multicast MBS session. The apparatus may further include receiving circuitry configured to perform receiving a join request reject message indication that the apparatus is not allowed to access the MBS session while roaming in the VPLMN. The apparatus may further include refraining circuitry configured to perform refraining to transmit further join request for that MBS session while roaming in the VPLMN.

In accordance with some example embodiments, a method may include transmitting, by a user equipment, a request to join a multicast MBS session. The method may further include roaming in a VPLMN. The method may further include receiving, by the UE, an indication that the UE is removed from the MBS session with a cause indicating that the UE is not allowed to access the MBS multicast session while roaming. The method may further include refraining to transmit further join request for that MBS multicast session while roaming.

In accordance with certain example embodiments, an apparatus may include means for transmitting a request to join a multicast MBS session. The apparatus may further include means for roaming in a VPLMN. The apparatus may further include means for receiving an indication that the apparatus is removed from the MBS session with a cause indicating that the apparatus is not allowed to access the MBS multicast session while roaming. The apparatus may further include means for refraining to transmit further join request for that MBS multicast session while roaming.

In accordance with various example embodiments, a non-transitory computer readable medium may include program instructions that, when executed by an apparatus, cause the apparatus to perform at least a method. The method may include transmitting a request to join a multicast MBS session. The method may further include roaming in a VPLMN. The method may further include receiving an indication that the apparatus is removed from the MBS session with a cause indicating that the apparatus is not allowed to access the MBS multicast session while roaming. The method may further include refraining to transmit further join request for that MBS multicast session while roaming.

In accordance with some example embodiments, a computer program product may perform a method. The method may include transmitting a request to join a multicast MBS session. The method may further include roaming in a VPLMN. The method may further include receiving an indication that the apparatus is removed from the MBS session with a cause indicating that the apparatus is not allowed to access the MBS multicast session while roaming. The method may further include refraining to transmit further join request for that MBS multicast session while roaming.

In accordance with certain example embodiments, an apparatus may include at least one processor and at least one memory storing instructions that, when executed by the at least one processor, cause the apparatus at least to transmit a request to join a multicast MBS session. The at least one memory and instructions, when executed by the at least one processor, may further cause the apparatus at least to roam in a VPLMN. The at least one memory and instructions, when executed by the at least one processor, may further cause the apparatus at least to receive an indication that the apparatus is removed from the MBS session with a cause indicating that the apparatus is not allowed to access the MBS multicast session while roaming. The at least one memory and instructions, when executed by the at least one processor, may further cause the apparatus at least to refrain to transmit further join request for that MBS multicast session while roaming.

In accordance with various example embodiments, an apparatus may include transmitting circuitry configured to perform transmitting a request to join a multicast MBS session. The apparatus may further include roaming circuitry configured to perform roaming in a VPLMN. The apparatus may further include receiving circuitry configured to perform receiving an indication that the apparatus is removed from the MBS session with a cause indicating that the apparatus is not allowed to access the MBS multicast session while roaming. The apparatus may further include refraining circuitry configured to perform refraining to transmit further join request for that MBS multicast session while roaming.

In accordance with some example embodiments, a method may include transmitting, by a user equipment, a request to join a multicast MBS session. The method may further include roaming in a VPLMN. The method may further include receiving, by the UE, an indication that the UE is removed from the MBS session with a cause indicating that the UE is not allowed to access the MBS multicast session while roaming in the VPLMN. The method may further include refraining to transmit further join request for that MBS multicast session while roaming in the VPLMN.

In accordance with certain example embodiments, an apparatus may include means for transmitting a request to join a multicast MBS session. The apparatus may further include means for roaming in a VPLMN. The apparatus may further include means for receiving an indication that the apparatus is removed from the MBS session with a cause indicating that the apparatus is not allowed to access the MBS multicast session while roaming in the VPLMN. The apparatus may further include means for refraining to transmit further join request for that MBS multicast session while roaming in the VPLMN.

In accordance with various example embodiments, a non-transitory computer readable medium may include program instructions that, when executed by an apparatus, cause the apparatus to perform at least a method. The method may include transmitting a request to join a multicast MBS session. The method may further include roaming in a VPLMN. The method may further include receiving an indication that the apparatus is removed from the MBS session with a cause indicating that the apparatus is not allowed to access the MBS multicast session while roaming in the VPLMN. The method may further include refraining to transmit further join request for that MBS multicast session while roaming in the VPLMN.

In accordance with some example embodiments, a computer program product may perform a method. The method may include transmitting a request to join a multicast MBS session. The method may further include roaming in a VPLMN. The method may further include receiving an indication that the apparatus is removed from the MBS session with a cause indicating that the apparatus is not allowed to access the MBS multicast session while roaming in the VPLMN. The method may further include refraining to transmit further join request for that MBS multicast session while roaming in the VPLMN.

In accordance with certain example embodiments, an apparatus may include at least one processor and at least one memory storing instructions that, when executed by the at least one processor, cause the apparatus at least to transmit a request to join a multicast MBS session. The at least one memory and instructions, when executed by the at least one processor, may further cause the apparatus at least to roam in a VPLMN. The at least one memory and instructions, when executed by the at least one processor, may further cause the apparatus at least to receive an indication that the apparatus is removed from the MBS session with a cause indicating that the apparatus is not allowed to access the MBS multicast session while roaming in the VPLMN. The at least one memory and instructions, when executed by the at least one processor, may further cause the apparatus at least to refrain to transmit further join request for that MBS multicast session while roaming in the VPLMN.

In accordance with various example embodiments, an apparatus may include transmitting circuitry configured to perform transmitting a request to join a multicast MBS session. The apparatus may further include roaming circuitry configured to perform roaming in a VPLMN. The apparatus may further include receiving circuitry configured to perform receiving an indication that the apparatus is removed from the MBS session with a cause indicating that the apparatus is not allowed to access the MBS multicast session while roaming in the VPLMN. The apparatus may further include refraining circuitry configured to perform refraining to transmit further join request for that MBS multicast session while roaming in the VPLMN.

### BRIEF DESCRIPTION OF THE DRAWINGS

For a proper understanding of example embodiments, reference should be made to the accompanying drawings, wherein:

FIGS. 1A-1C illustrate an example of a signaling diagram of a UE join procedure in VPLMN for multicast MBS services provided by an HPLMN according to certain example embodiments;

FIGS. 2A-2C illustrate an example of a signaling diagram when a UE that has joined a multicast MBS session in an HPLMN is moving from a HPLMN to a VPLMN, and the UE is authorized to continue receiving the multicast MBS session according to various example embodiments;

FIGS. 3A-3D illustrate an example of a signaling diagram when a UE that had joined a multicast MBS session in an HPLMN is moving from the HPLMN to a VPLMN, and the UE is not authorized to continue receiving the multicast MBS session according to various example embodiments;

FIG. 4 illustrates an example of a flow diagram of a method according to certain example embodiments;

FIG. 5 illustrates an example of a flow diagram of a method according to some example embodiments;

FIG. 6 illustrates an example of a flow diagram of a method according to various example embodiments;

FIG. 7 illustrates an example of a flow diagram of a method according to certain example embodiments;

FIG. 8 illustrates an example of a flow diagram of a method according to some example embodiments;

FIG. 9 illustrates an example of a flow diagram of a method according to various example embodiments;

FIG. 10 illustrates an example of a flow diagram of a method according to certain example embodiments;

FIG. 11 illustrates an example of a flow diagram of a method according to some example embodiments;

FIG. 12 illustrates an example of a flow diagram of a method according to some example embodiments;

FIG. 13 illustrates an example of various network devices according to some example embodiments;

FIG. 14 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for supporting multicast services is not intended to limit the scope of certain example embodiments, but is instead representative of selected example embodiments.

Currently, roaming is not supported for multicast and broadcast system (MBS) services, but 3GPP Rel-19 is expected to add support of MBS services for roaming UEs. A home session management function (H-SMF) of a home public land mobile network (HPLMN) may perform authorization checks for UEs joining or leaving multicast sessions provided by the HPLMN. When a UE is roaming from its HPLMN to a visited PLMN (VPLMN), and attempts to join or leave a multicast MBS session that is provided by its HPLMN, a UE join or leave message may be received by a visited SMF (V-SMF) of the VPLMN, which may be unaware of the roaming outbound restrictions in the HPLMN. Thus, such authorization checks cannot currently be performed.

Additionally, a UE may successfully join a multicast MBS service in its HPLMN, and roam to a VPLMN due to UE mobility (i.e., inter-PLMN handover or registration). However, the multicast MBS service that the UE has joined in its HPLMN may or may not be authorized in the VPLMN. As a result, there is currently no suitable architecture defined to continue supporting the multicast MBS session in the VPLMN when the UE is authorized to continue receiving the multicast MBS traffic in VPLMN. Similarly, there is no suitable architecture to prevent the UE from receiving the multicast MBS service in the VPLMN when the UE is not authorized to continue receiving the multicast MBS traffic in VPLMN.

Certain example embodiments described herein may have various benefits and/or advantages to overcome the disadvantages described above. For example, certain example embodiments may provide roaming authorization checks in order to support the procedures of the UE to join and leave handover multicast MBS sessions that are provided by its HPLMN while the UE is within a VPLMN or roaming to a VPLMN. Some example embodiments may introduce architecture changes needed to support multicast MBS services in roaming scenarios for inter-PLMN mobility, where current architecture doesn't support these scenarios, and/or may reuse some existing architecture to improve compatibility. Thus, certain example embodiments discussed below are directed to improvements in computer-related technology.

While various embodiments provided herein relate to PLMNs, any such embodiments may also apply to roaming between standalone non-public networks (SNPNs). In certain example embodiments, for a UE that is roaming from a HPLMN to a VPLMN (i.e., inter-PLMN mobility) that wants to receive multicast MBS services in VPLMN that is provided by the HPLMN, shared MBS traffic delivery may not be used for that MBS service in VPLMN, and instead MBS individual traffic delivery may be used. Furthermore, a home-routed protocol data unit (PDU) session architecture may be used in which the V-SMF communicates with the H-SMF for the PDU session operations. During the establishment of the home-routed PDU session, or during the insertion or change of V-SMF, an N9 (e.g., General Packet Radio Service Tunnelling Protocol (GTP)-U) tunnel may be established between the new V-UPF and the H-UPF. Additionally, the H-SMF may serve as the network function that interacts with a H-MB-SMF that provides the MBS service, while the H-MB-SMF may serve as the network function that interacts with the H-MB-UPF. In this way, MBS data may flow from a home multicast/broadcast session management function (H-MB-UPF) towards the home user plane function (H-UPF) (e.g., controlled by the H-SMF), from the H-UPF towards the visited user place function (V-UPF) (e.g., controlled by the V-SMF), and then towards the gNB serving the UE.

In various example embodiments, a UE that is roaming in a VPLMN may want to join a multicast MBS service provided by the HPLMN (i.e., outbound roamer). For example, the UE may trigger a join request (i.e., PDU SESSION MODIFICATION procedure or PDU SESSION ESTABLISHMENT procedure) towards the V-SMF in the VPLMN to join the multicast MBS session. The MBS related request from the UE in VPLMN (e.g., join a new multicast MBS session) may need to be newly signaled from the V-SMF to H-SMF, and be responded to in the reverse direction. The V-SMF may determine, based on the PDU session used by the UE, whether to forward the join request to H-SMF or to process the request itself. For example, for home-routed PDU sessions, multicast MBS services may be provided by the HPLMN and, thus, the H-SMF may be contacted. Similarly, for local break-out PDU sessions, the multicast MBS service may be provided by the VPLMN. In the case where the H-SMF is contacted, the H-SMF may then contact the H-MB-SMF to obtain the multicast MBS service related information, including the multicast quality of service (QOS) flow information.

The H-SMF may then check if the roaming UE is authorized to join the multicast MBS service provided by HPLMN while the UE is roaming in this particular VPLMN (i.e., outbound roamer) or any VPLMN in general. The information about the multicast roaming authorization may be pre-configured in the HPLMN, or may be provided by the application function (AF) (e.g., at the establishment of the MBS session), or may be obtained from the unified data management (UDM) (e.g., from the user subscription data).

In certain example embodiments, if the roaming UE is not authorized to join the multicast MBS service in the VPLMN, the H-SMF may reject the multicast join request back to the V-SMF (e.g., with a cause indicating that the UE is not authorized to join the MBS session from the VPLMN or from any VPLMN), and the V-SMF may reject the request back to the UE (e.g., while transmitting the error cause raised by the H-SMF). The UE may not request joining in the future if the UE is in the same VPLMN and/or from any VPLMN based on the cause received.

In some other example embodiments, if the roaming UE is authorized to join the multicast MBS service in VPLMN, the H-SMF may prepare for individual MBS delivery from the H-MB-UPF to the H-UPF (i.e., protocol data unit session anchor (PSA) UPF) (e.g., even if MBS shared traffic delivery is used in HPLMN for that multicast MBS service), and may map the received information from H-MB-SMF about the multicast QoS flows into PDU session's unicast QoS flows information. The H-SMF may signal these unicast QoS flows to V-SMF either in the response to the V-SMF and/or in a subsequent PDU session modification request towards the V-SMF.

Once the H-SMF has signaled these unicast QoS flows to V-SMF, the H-SMF may respond to the V-SMF to indicate acceptance of a multicast join request. For example, the H-SMF may respond while keeping the VPLMN agnostic of MBS session/multicast MBS flows associated with a PDU session. Specifically, the H-SMF may request the V-SMF to establish the unicast QoS flows (e.g., associated with the MBS service) without indicating that they are related to the multicast MBS service/multicast QoS flows. In this way, the response may pass from the V-SMF to the V-AMF, and from the V-AMF to the V-NG-RAN without an indication that the new QoS flows relate to the Multicast MBS service in the N2 message as well. Thus, the VPLMN may be unaware that the unicast QoS flows used for the MBS service are related to an MBS service, and accordingly, the NG-RAN of VPLMN may be unaware as well and not try to establish shared delivery. The VPLMN may then handle the unicast QoS flows like regular/non-MBS QoS flows of a PDU session. The VPLMN (e.g., V-SMF and V-NG-RAN) may handle the unicast QoS flows like regular/non-MBS QoS flows, and may not request the establishment of shared delivery.

In another example, the H-SMF may respond with the VPLMN being aware of MBS session/multicast MBS flows associated with a PDU session. For example, in addition to requesting the new unicast QoS flows, as described above, the H-SMF may additionally include a new indication in the response to V-SMF that indicates “shared MBS traffic delivery shall not be used,” “individual delivery shall be used,” or “roaming UE.”

The response may be piggy-backed into a next generation application protocol (NGAP) message, which may also include the new indication that “shared MBS traffic delivery shall not be used,” “individual delivery used,” or “roaming UE” that goes from V-AMF to V-NG-RAN; thus, V-NG-RAN may not establish the shared MBS traffic delivery for this multicast MBS session. Alternatively, if no indication is received, by default multicast individual delivery is to be setup. Alternatively, the V-NG-RAN may have been informed in the UE context setup message that the UE is in roaming situation or has received the HPLMN identifier of the UE so that the V-NG-RAN is aware that the UE is a roaming UE, and based on this, the V-NG-RAN may not establish the shared MBS traffic delivery for this multicast MBS session.

In various example embodiments, the UE may be provided with a Join_Accept message (e.g., via a DL PDU SESSION MODIFICATION COMMAND message) from the V-SMF. If the join request is sent in a PDU session establishment request (as it can also be sent via PDU session modification request based on 3GPP Rel-17 procedures for joining), the V-SMF and the H-SMF may exchange transport addresses to start establishing an N9 tunnel between the V-UPF and H-UPF may also serve for the delivery of the multicast MBS session traffic. If the H-UPF is not yet receiving the MBS multicast data, the H-SMF may request from the H-MB-SMF to establish the unicast transport tunnel for multicast MBS session delivery between H-MB-UPF and H-UPF. The H-SMF may then configure the H-UPF to transmit MBS multicast data received from the H-MB-UPF as unicast QoS flow within the PDU session N9 tunnel towards the V-UPF. The V-SMF may configure the V-UPF to forward the related QoS flow as a home routed PDU session flow. On the user plane side, and after the roaming UE has successfully joined the MBS session, the multicast MBS traffic therefore travels via the AF, H-MB-UPF, PSA UPF (H-UPF), V-UPF, V-NG-RAN, and finally to the UE.

Certain example embodiments may relate to a UE roaming in a VPLMN that is configured to leave a multicast MBS service provided by the HPLMN (i.e., outbound roamers). For example, the UE may trigger a leave request (e.g., PDU SESSION MODIFICATION procedure) towards the V-SMF in the VPLMN to leave the multicast MBS session. The MBS related request from the UE in VPLMN (i.e., Leave the multicast MBS session) may need to be newly signaled from the V-SMF to H-SMF, and a response sent in the reverse direction. V-SMF may then decide based on the PDU session used by the UE whether to forward the leave request to H-SMF or to process the request by itself. For example, for home-routed PDU session, multicast MBS service may be provided by HPLMN, and the H-SMF may be contacted. But for local break-out PDU sessions, multicast MBS service may be provided by VPLMN. After the UE leaves the multicast MBS service, the H-SMF may request the V-SMF to remove the unicast QoS flows that were established for the unicast delivery of the multicast MBS service. The V-SMF may then request the V-NG-RAN node (e.g., via the V-AMF) to remove the unicast QoS flows. The H-SMF may also configure the H-UPF to stop transmitting MBS multicast data received from the H-MB-UPF as unicast QoS flow within the PDU session N9 tunnel towards the V-UPF. The H-SMF may also request from the H-MB-SMF to remove the unicast MBS session transport tunnels between H-MB-UPF and PSA UPF (e.g., H-UPF) if no remaining UEs remain to be served by that PSA UPF for this MBS service.

In certain example embodiments, a UE has successfully joined a multicast MBS session in its HPLMN. The UE may be transitioning from HPLMN to VPLMN (i.e., inter-PLMN mobility). The HPLMN may then determine whether the UE is authorized to continue receiving the multicast MBS service.

During the HPLMN to VPLMN handover preparation, a V-SMF insertion may occur with the V-SMF transmitting an Nsmf_PDUSession_Create Request to the H-SMF including the VPLMN ID (i.e., serving network). During the handover operation, the H-AMF may receive a Handover_required message from the H-NG-RAN that may include an N2SM Container Handover Required Transfer information element (IE), which in turn may include the multicast MBS session information of the MBS session(s) that the UE has joined, together with the associated PDU session(s). The Handover Required Transfer IE may be transparently relayed by the H-AMF forwarding the information to the V-AMF which in turn may forward this information to the V-SMF. The V-SMF may then forward the information to the H-SMF. Based on its knowledge that the UE earlier joined the multicast MBS session using this PDU session, the H-SMF may determine whether the roaming UE is authorized to continue receiving the multicast MBS service provided by HPLMN while the UE is roaming in this particular VPLMN (outbound roamers) or in any V-PLMN in general. The information about the multicast roaming authorization may be pre-configured in the HPLMN, configured by the AF, or obtained from the UDM (e.g., user subscription data).

Some example embodiments may include the VPLMN being agnostic of MBS session/multicast MBS flows associated with a PDU session. For example, if the H-SMF determines that the UE is not authorized to continue receiving the multicast MBS service in the VPLMN, the H-SMF may request the V-SMF to remove any unicast QoS flows associated with the multicast MBS services from the PDU session. It is assumed that these QoS flows were requested to be handed over to the VPLMN. The V-SMF may then remove the unauthorized roaming UE from the multicast MBS service by not including the MBS associated unicast QoS flows in the Handover Request message towards the V-NG-RAN. Additionally or alternatively, the H-SMF may request the V-SMF to indicate to the UE that the UE is removed from the MBS multicast session, with a cause indicating that the UE is not authorized to join the MBS session from the VPLMN it is roaming into or from any VPLMN. UE may not request joining in the future in such case if the UE is in the same VPLMN or from any VPLMN based on the cause received.

The H-SMF may trigger a PDU session modification procedure towards the V-SMF, or alternatively, as a response to the PDU Session Create Request. If individual delivery was used before, the H-SMF may also configure the H-UPF to stop transmitting MBS multicast data received from the H-MB-UPF as unicast QoS flow within the PDU session N9 tunnel towards the V-UPF.

In various example embodiments, if the H-SMF determines that the UE is authorized to continue receiving the multicast MBS service in the VPLMN, the H-SMF may request the V-SMF to establish the unicast QoS flows associated with the multicast MBS services for the PDU session, if shared delivery was used in the HPLMN before the inter-PLMN mobility and no associated QoS flows were provided to the NG-RAN, and may map the QoS information of the multicast QoS Flow into PDU Session's unicast QoS Flow information and include this information in the response to V-SMF. For this, the H-SMF may trigger a PDU session modification procedure towards the V-SMF or alternatively as a response to the PDU Session Create Request. If individual delivery was not used before, the H-SMF may also configure the H-UPF to transmit MBS multicast data received from the H-MB-UPF as unicast QoS flow within the PDU session N9 tunnel towards the V-UPF. In the above example, the H-SMF may not provide the multicast MBS related information to V-SMF and V-NG-RAN (i.e., VPLMN is agnostic of multicast MBS session).

Certain example embodiments may include the VPLMN being aware of MBS session/multicast MBS flows associated with a PDU session. If the H-SMF determines that the UE is not authorized to continue receiving the multicast MBS service in the VPLMN, the H-SMF may request from the V-SMF to trigger the procedure of removing the unauthorized roaming UE from the multicast MBS service. The H-SMF may request the V-SMF to remove the unicast QoS flows associated with the multicast MBS services from the PDU session (e.g., if unicast delivery was also used in the HPLMN before the inter-PLMN mobility) (e.g., these QoS flows may have been requested to be handed over to the VPLMN). The V-SMF may then remove the joining of the unauthorized roaming UE from the multicast MBS service by not including the MBS associated unicast QoS flows in the Handover Request message towards the V-NG-RAN. The V-SMF may trigger the DL PDU SESSION MODIFICATION procedure towards the UE to indicate to the UE about its removal from the multicast MBS session. The V-SMF may provide the UE with a cause-possibly transmitted from H-SMF indicating that the UE is not authorized to join the MBS session from the VPLMN or from any VPLMN. UE may not request joining in the future if the UE is in the same VPLMN or from any VPLMN based on the cause received. If individual delivery was used before, the H-SMF may also configure the H-UPF to stop transmitting MBS multicast data received from the H-MB-UPF as unicast QoS flow within the PDU session N9 tunnel towards the V-UPF.

In certain example embodiments, it may include the VPLMN being aware of MBS session/multicast MBS flows associated with a PDU session. If the H-SMF determines that the UE is authorized to continue receiving the multicast MBS service in the VPLMN, the H-SMF may request the V-SMF to establish the unicast QoS flows associated with the multicast MBS services for the PDU session if shared delivery was used in the HPLMN before the inter-PLMN mobility, and may map the QoS information of the multicast QoS Flow into the PDU Session's unicast QoS Flow information, and include this information in the response to V-SMF. The H-SMF may respond to the V-SMF by indicating the new indication that “shared MBS traffic delivery shall not be used,” “individual delivery,” or “roaming UE.” Alternatively, if no indication is received, default multicast individual delivery may be set up.

The V-SMF provides the response back to V-AMF which goes to V-NG-RAN where the new indication that “shared MBS traffic delivery shall not be used,” “individual delivery,” or “roaming UE” is piggy-backed in an NG application protocol message. Since the response includes the new indication that “shared MBS traffic delivery shall not be used,” V-NG-RAN doesn't establish the shared MBS traffic delivery for this multicast MBS session. Alternatively, the V-AMF may transmit to the V-NG-RAN an indication that the UE is a roaming UE or may transmit to the V-NG-RAN the HPLMN ID of the UE and upon determining that the UE is a roaming UE the V-NG-RAN decides to not trigger the shared MBS traffic delivery setup.

In order to establish the individual MBS traffic delivery, the V-SMF and the H-SMF may exchange transport addresses to set up the unicast tunnel between PSA UPF (e.g., H-UPF) and V-UPF if not already setup. If individual delivery was not used before, the H-SMF may also configure the H-UPF to transmit MBS multicast data received from the H-MB-UPF as unicast QoS flow within the PDU session N9 tunnel towards the V-UPF. On the user plane side, and after the roaming UE has successfully joined the MBS session, the multicast MBS traffic may be transferred via the AF, H-MB-UPF, PSA UPF (H-UPF), V-UPF, V-NG-RAN, and finally to the UE.

Certain example embodiments may include the UE moving from VPLMN to HPLMN. For example, upon mobility from VPLMN to HPLMN, if the UE may be allowed to join the MBS service in the source VPLMN, and if shared delivery can be used in the HPLMN, the H-SMF may remove the QoS Flows for unicast delivery, and switch to shared delivery during or just after the inter-PLMN mobility.

Various example embodiments may include the UE moving from a VPLMN 1 to a VPLMN 2. In this scenario, some techniques described above (e.g., HPLMN to VPLMN) may apply, but if the UE was authorized to join the multicast MBS service in the source VPLMN 1, and is also authorized to do so in the target VPLMN 2, the H-SMF may not establish new unicast QoS flows, since the existing QoS flows are expected to be handed over from VPLMN 1 to VPLMN 2 as per regular/non-MBS QoS flows.

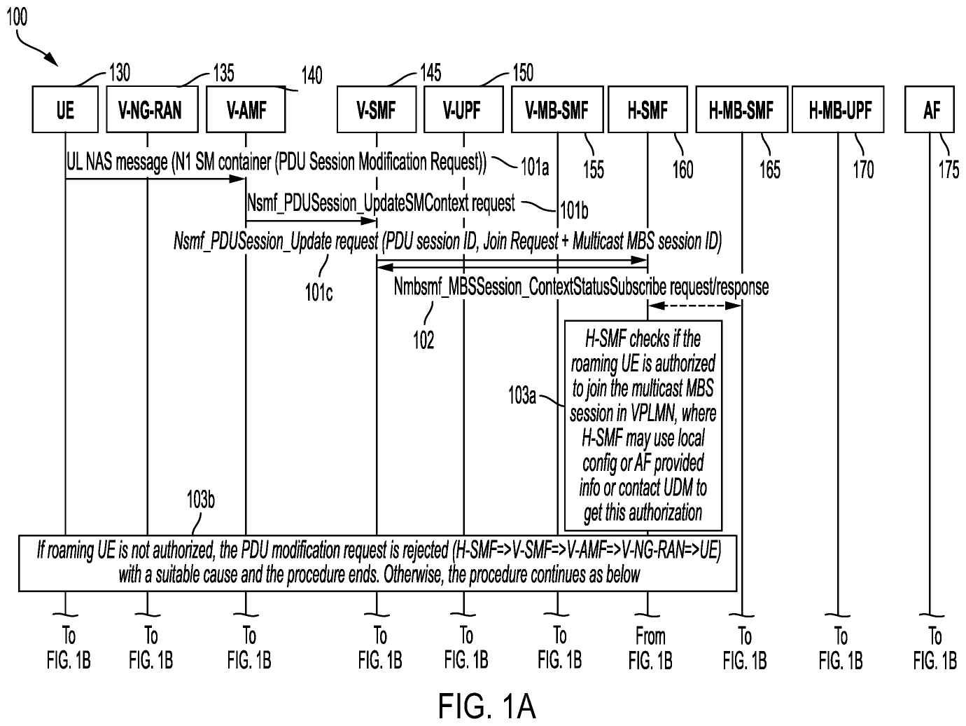

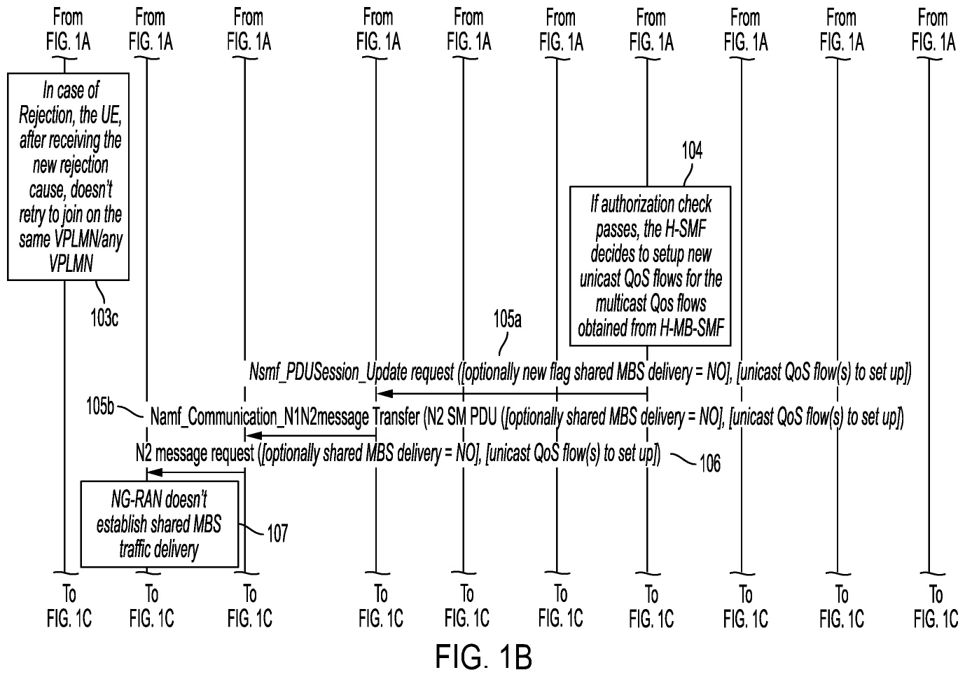

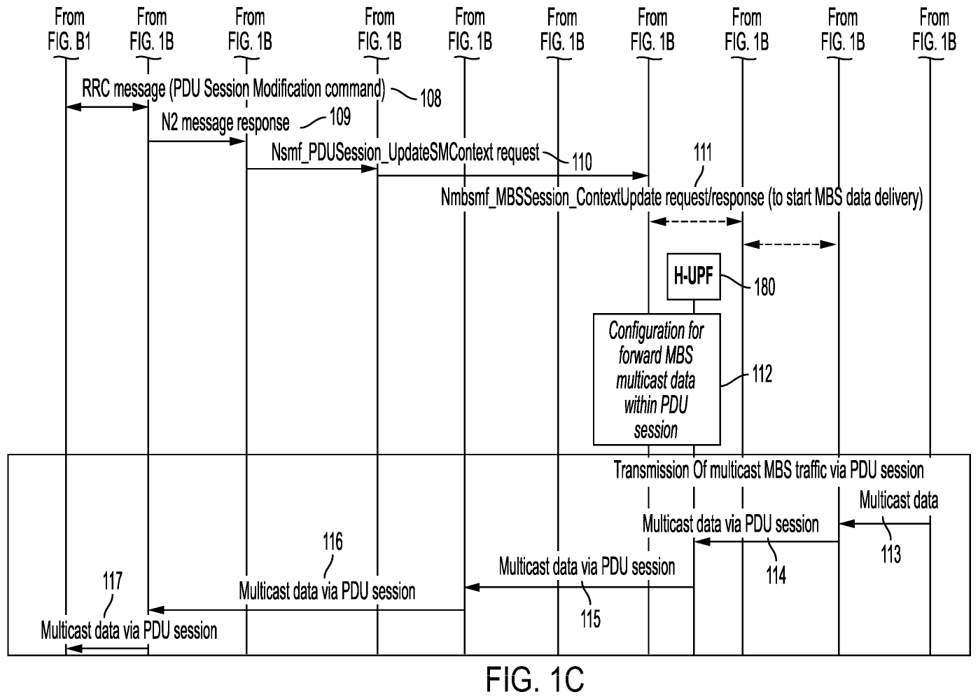

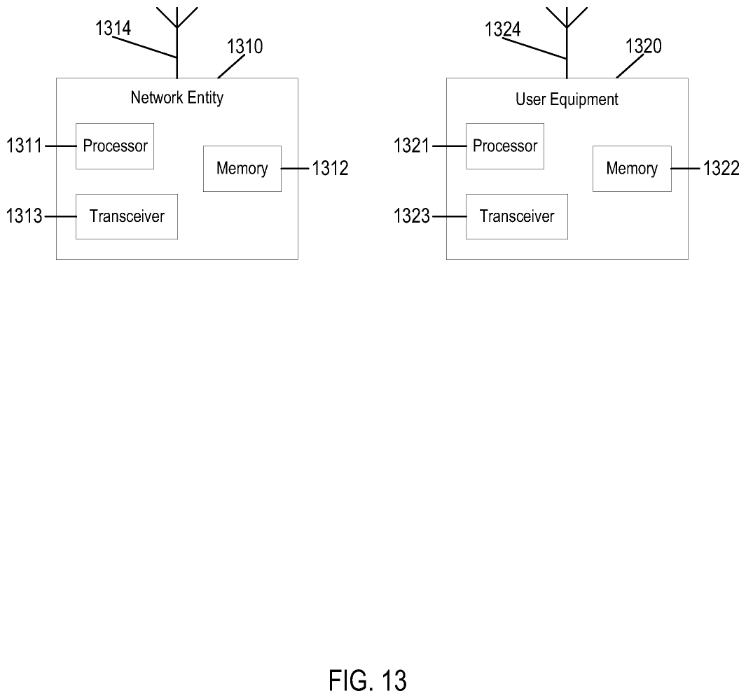

FIGS. 1A-1C illustrate an example of a signaling diagram 100 depicting a UE join procedure in VPLMN for multicast MBS service provided by HPLMN. UE 130 may be similar to UE 1320, and V-NG-RAN 135, V-AMF 140, V-SMF 145, V-UPF 150, V-MB-SMF 155, H-SMF 160, H-MB-SMF 165, H-MB-UPF 170, and AF 175 may be similar to NE 1310 and, as illustrated in FIG. 13, according to certain example embodiments.

At operation 101a, UE 130 may transmit a UL NAS message (e.g., N1 SM container (PDU Session Modification Request)) to V-AMF 140.

At operation 101b, V-AMF 140 may transmit an Nsmf_PDUSession_UpdateSMContext request to V-SMF 145.

At operation 101c, V-SMF 145 may transmit to H-SMF 160 an Nsmf_PDUSession_Update request (PDU session ID, Join Request+Multicast MBS session ID), followed by a response returned to V-SMF 145.

At operation 102, H-SMF 160 and H-MB-SMF 165 may exchange a Nmbsmf_MBSSession_ContextStatusSubscribe request and response message.

At operation 103a, H-SMF 160 may determine whether UE 130 is authorized to join the multicast MBS session in VPLMN, where H-SMF 160 may use a local configuration, information provided by AF 175, and/or contact a UDM to receive this authorization.

At operation 103b, if H-SMF 160 determines that UE 130 is not authorized, the PDU modification request may be rejected and the rejection information may be transmitted from H-SMF 160 to V-SMF 145, V-AMF 140, V-NG-RAN 135, and then UE 130.

At operation 103c, upon receiving the rejection information at operation 103b, UE 130 may, after receiving the rejection cause, discontinue attempting to join the MBS session in the same VPLMN or any other VPLMN.

At operation 104, if the authorization check at operation 103a succeeds, H-SMF 160 may determine to set up a new unicast QoS flow for the multicast QoS flow obtained from H-MB-SMF 165.

At operation 105a, H-SMF 160 may transmit to V-SMF 145 an Nsmf_PDUSession_Update request, which may include a flag indicating shared MBS delivery is not permitted, as well as that unicast QoS flows should be set up.

At operation 105b, V-SMF 145 may transmit to V-AMF 140 an Namf_Communication_NIN2message transfer, which may be a N2 SM PDU which may include the flag (when received) indicating shared MBS delivery is not permitted, as well as unicast QoS flows should be set up.

At operation 106, V-AMF 140 may transmit to V-NG-RAN 135 an N2 message request which may include the flag indicating shared MBS delivery is not permitted, as well as that unicast QoS flows should be set up.

At operation 107, V-NG-RAN 135 may not establish shared MBS traffic delivery.

At operation 108, UE 130 and V-NG-RAN 135 may exchange an RRC message including a PDU session modification command.

At operation 109, V-NG-RAN 135 may transmit to V-AMF 140 an N2 message response.

At operation 110, V-AMF 140 may transmit to V-SMF 145 an Nsmf_PDUSession_UpdateSMContext request, which may be forwarded to H-SMF 160.

At operation 111, H-SMF 160, H-MB-SMF 165, and H-MB-SMF 170 may exchange an Nbmsmf_MBSSession_ContextUpdate request and response configured to start MBS data delivery.

At operation 112, H-SMF 160 and H-UPF 180 may generate a configuration for forwarding MBS multicast data within the PDU session.

At operation 113, AF 175 may transmit multicast data to H-MB-UPF 170, which may transmit the multicast data via PDU session to H-UPF 180 at operation 114.

At operation 115, H-UPF 180 may then transmit the multicast data via PDU session to V-UPF 150.

At operation 116, V-UPF 150 may transmit the multicast data via PDU session to V-NG-RAN 135, which may transmit the multicast data via PDU session to UE 130 at operation 117.

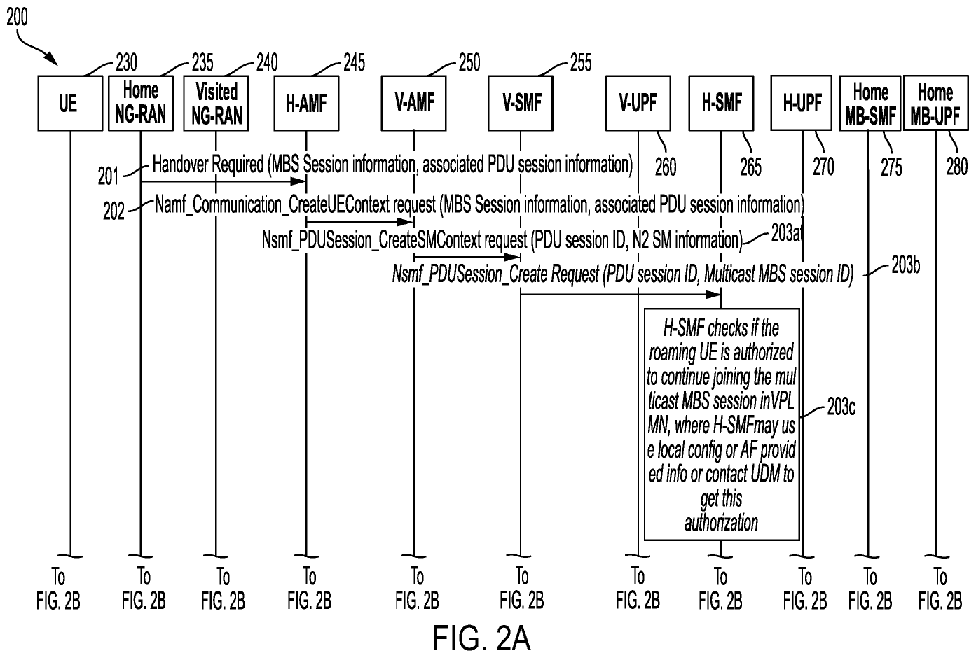

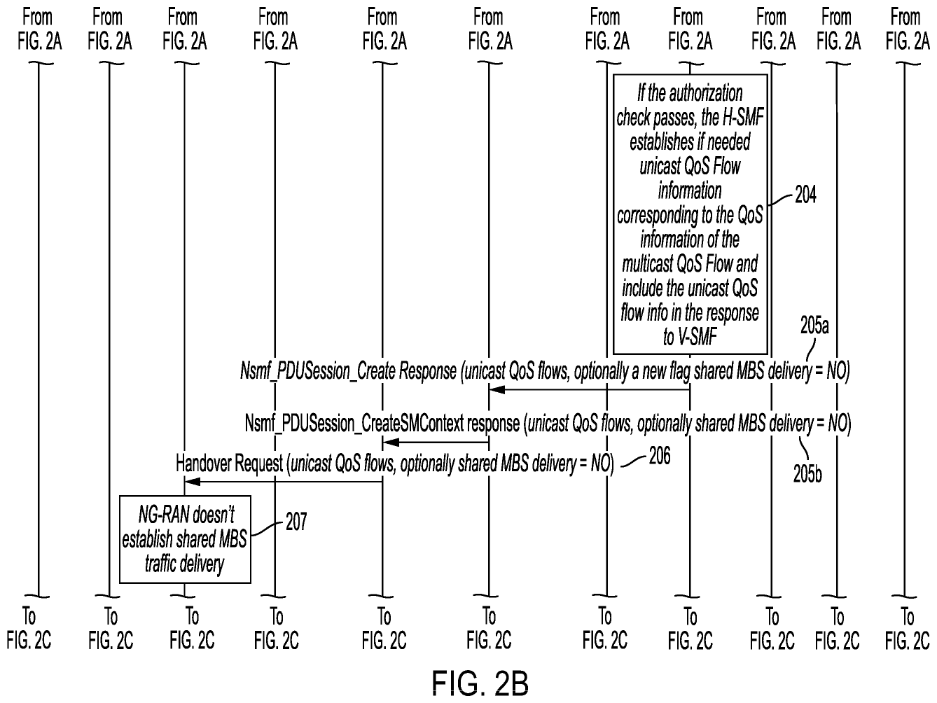

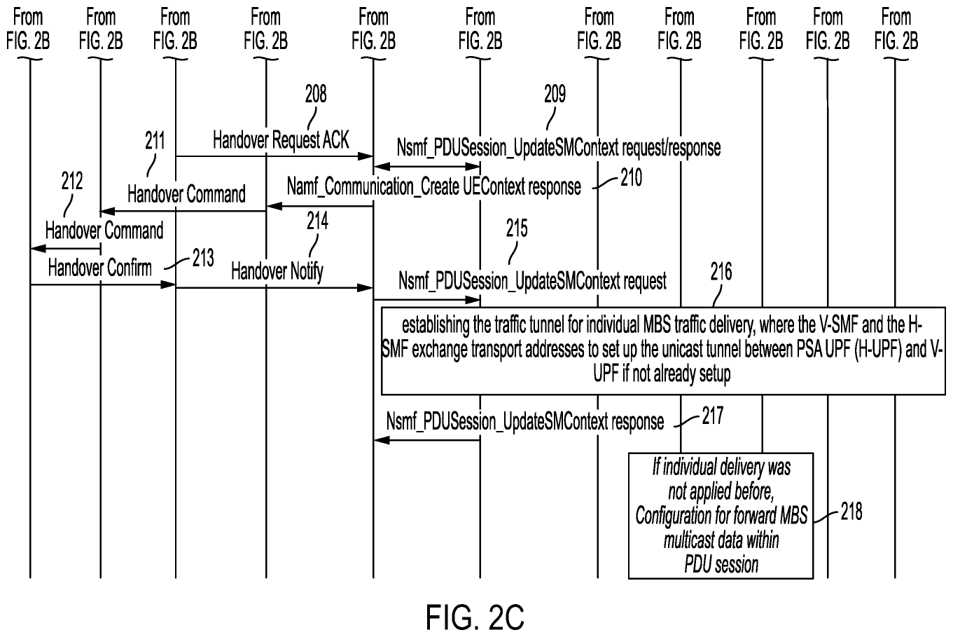

FIGS. 2A-2C illustrate an example of a signaling diagram 200 when a UE that has joined a multicast MBS session in HPLMN is moving from HPLMN to VPLMN and the UE is authorized to continue receiving the multicast MBS session. UE 230 may be similar to UE 1320, and Home NG-RAN 235, Visited NG-RAN 240, H-AMF 245, V-AMF 250, V-SMF 255, V-UPF 260, H-SMF 265, H-UPF 270, Home MB-SMF 275, and Home MB-UPF 280 may be similar to NE 1310 and, as illustrated in FIG. 13, according to certain example embodiments.

At operation 201, home NG-RAN 235 may transmit to H-AMF 245 a handover required message that include MBS session information and/or associated PDU session information.

At operation 202, H-AMF 245 may transmit to V-AMF 250 an Namf_Communication_CreateUEContext request message including the MBS session information and/or associated PDU session information.

At operation 203a, V-AMF 250 may transmit to V-SMF 255 an Nsmf_PDUSession_CreateSMContext request including the PDU session ID and/or N2 SM information.

At operation 203b, V-SMF 255 may transmit to H-SMF 265 a NSmf_PDUSession_Create request including the PDU session ID and/or multicast MBS session ID.

At operation 203c, H-SMF 265 may check whether roaming UE 230 is authorized to continue joining the multicast MBS session in the VPLMN, where H-SMF 265 may use a location configuration, information received from an AF, or request authorization from an UDM.

At operation 204, if the authorization check passes, H-SMF 265 may determine if needed unicast QoS flow information corresponding to the QoS information of the multicast QOS flow, including the unicast QoS flow information in the response to V-SMF 255.

At operation 205a, H-SMF 265 may transmit to V-SMF 255 a Nsmf_PDUSession_Create response, including unicast QoS flows, and optionally a flag indicating shared MBS delivery is not allowed.

At operation 205b, V-SMF 255 may transmit to V-AMF 250 a Nsmf_PDUSession_CreateSMContext response, including the unicast QoS flows, and optionally the flag indicating shared MBS delivery is not allowed.

At operation 206, V-AMF 250 may transmit to Visited NG-RAN 240 a handover request, including the unicast QoS flows, and optionally the flag indicating shared MBS delivery is not allowed.

At operation 207, Visited NG-RAN 240 may not establish shared MBS traffic delivery.

At operation 208, Visited NG-RAN 240 may transmit to V-AMF 250 a handover request acknowledgement.

At operation 209, V-AMF 250 and V-SMF 255 may exchange a Nsmf_PDUSession_UpdateSMContext request and response.

At operation 210, V-AMF 250 may transmit to H-AMF 245 an Namf_Communiaction_Create UE context response. At operation 211, H-AMF 245 may transmit to Home NG-RAN 235 a handover command, which may forward an RRC handover command or reconfiguration to UE 230 at operation 212. At operation 213, UE 230 may transmit to Visited NG-RAN 240 a handover confirmation or handover completion indication. At operation 214, the Visited NG-RAN 240 may transmit a handover notification to V-AMF 250. At operation 215, V-AMF 250 may transmit to V-SMF 255 an Nsmf_PDUSession_UpdateSMContext request.

At operation 216, H-SMF 265 may establish a traffic tunnel for individual MBS traffic delivery, where V-SMF 255 and H-SMF 265 may exchange transport addresses to set up a unicast tunnel between PSA UPF (e.g., H-UPF 270) and V-UPF 260 if not already set up.

At operation 217, V-SMF 255 may transmit to V-AMF 250 an Nsmf_PDUSession_UpdateSMContext response.

At operation 218, H-SMF 265 may generate a configuration for forwarding MBS multicast data within a PDU session if individual delivery was not applied before.

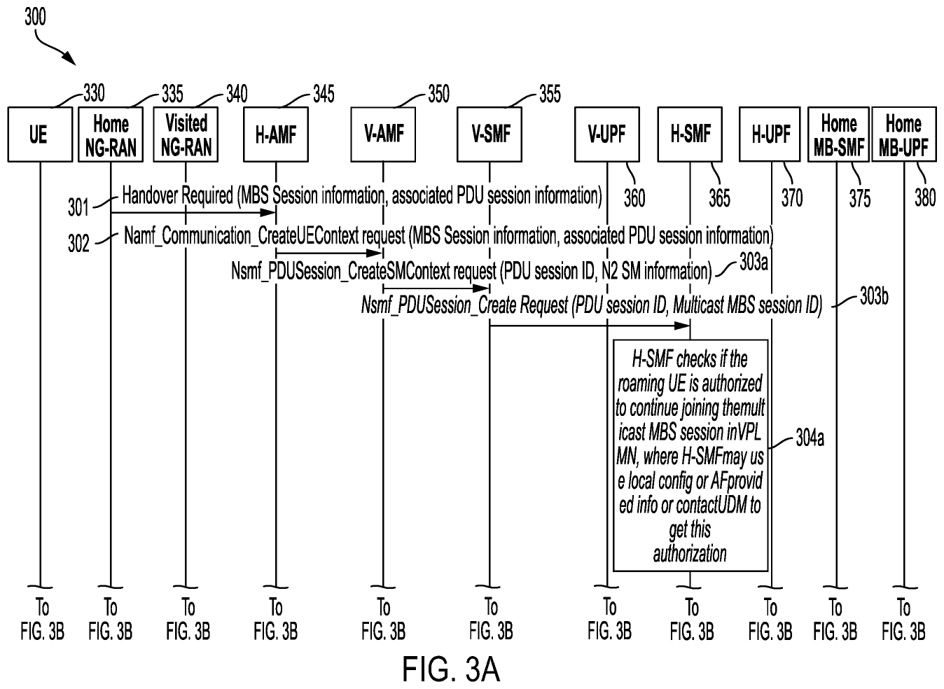

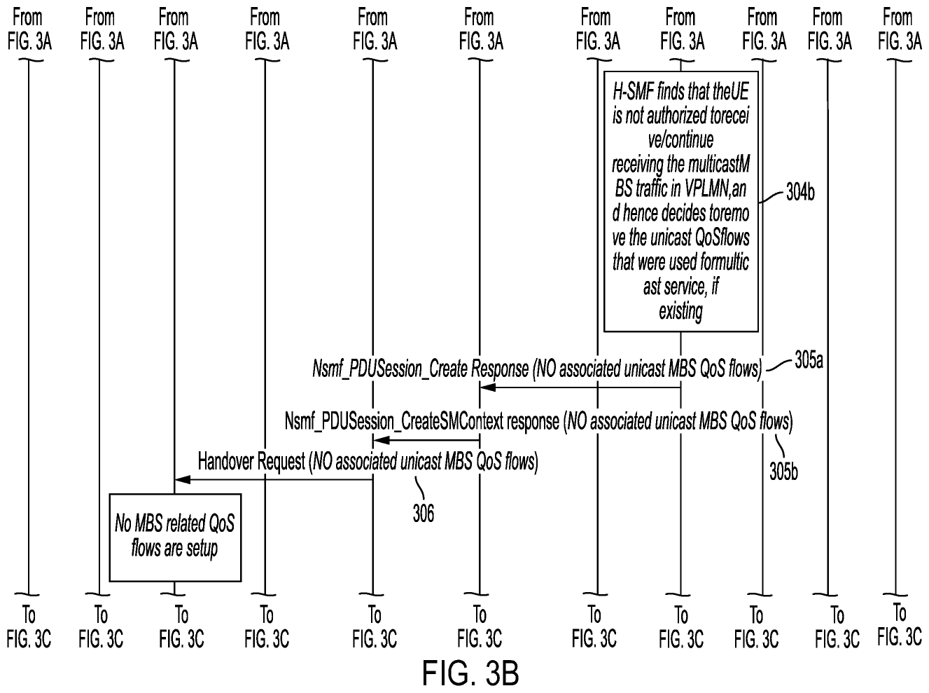

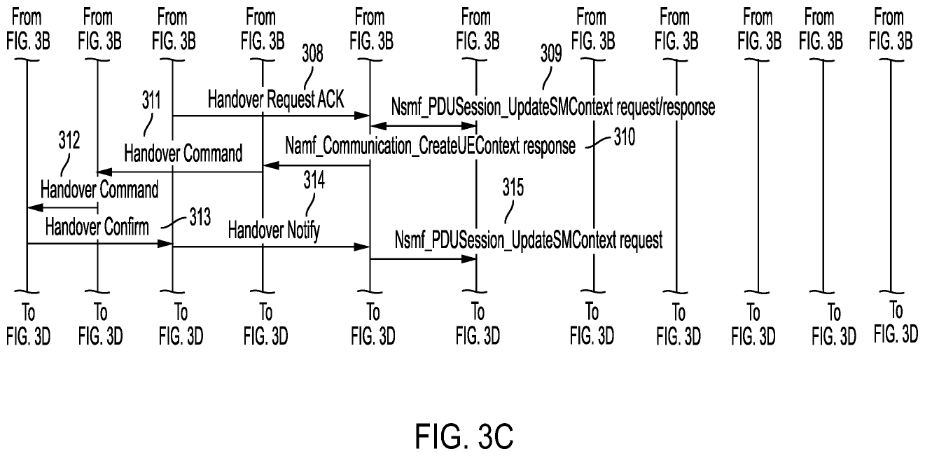

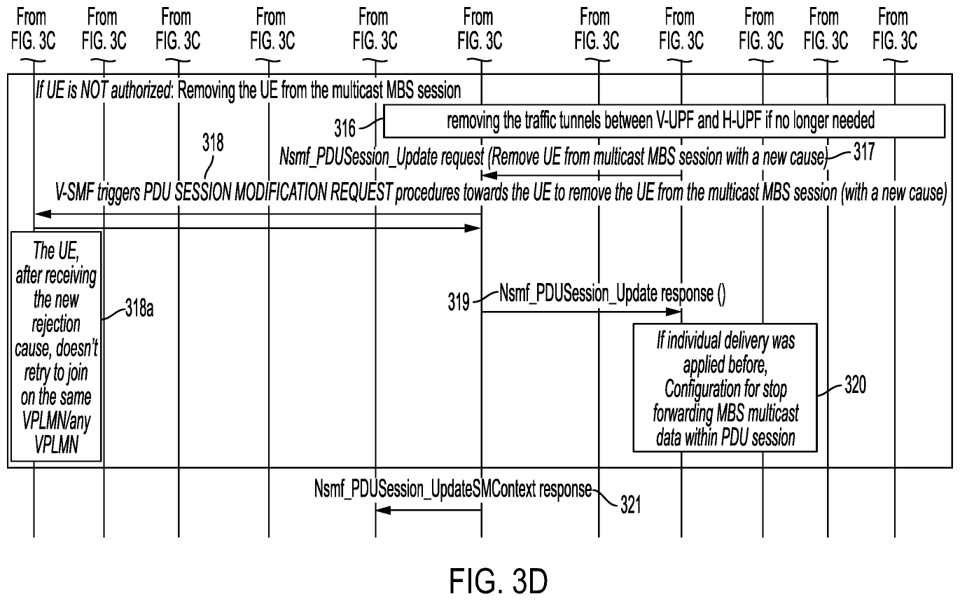

FIGS. 3A-3D illustrate an example of a signaling diagram 300 when a UE that had joined a multicast MBS session in HPLMN is moving from HPLMN to VPLMN and the UE is not authorized to continue receiving the multicast MBS session. UE 330 may be similar to UE 1320, and Home NG-RAN 335, Visited NG-RAN 340, H-AMF 345, V-AMF 350, V-SMF 355, V-UPF 360, H-SMF 365, H-UPF 370, Home MB-SMF 375, and Home MB-UPF 380 may be similar to NE 1310 and, as illustrated in FIG. 13, according to certain example embodiments.

At operation 301, Home NG-RAN 335 may transmit a Handover Required message to H-AMF 345 including MBS session information and/or associated PDU session information.

At operation 302, H-AMF 345 may transmit to V-AMF 350 an Namf_Communication_CreateUEContext request including the MBS session information and/or associated PDU session information.

At operation 303a, V-AMF 350 may transmit to V-SMF 355 an Namf_Communication_CreateSMContext request including a PDU session ID and/or N2 SM information.

At operation 303b, V-SMF 355 may transmit to H-SMF 365 an NSmf_PDUSession_Create request including the PDU session ID and/or multicast MBS session ID.

At operation 304a, H-SMF 365 may check if roaming UE 330 is authorized to continue joining the multicast MBS session in the VPLMN, where H-SMF 365 may use a location configuration, information provided by an AF, or contact a UDM to receive this authorization.

At operation 304b, H-SMF 365 may determine that UE 330 is not authorized to receive/continue receiving the multicast MBS traffic in VPLMN, and determine to remove the unicast QoS flows used for multicast service (if exists).

At operation 305a, H-SMF 365 may transmit to V-SMF 355 an Nsmf_PDUSession_Create response without associated unicast MBS QoS flows.

At operation 305b, V-SMF 355 may transmit to V-AMF 350 an Nsmf_PDUSession_CreateSMContext response without the associated unicast MBS QoS flows.

At operation 306, V-AMF 350 may transmit to Visited NG-RAN 340 a handover request without the associated unicast MBS QoS flows.

At operation 307, no related MBS related QoS flows may be setup.

At operation 308, Visited NG-RAN 340 may transmit to V-AMF 350 a handover request acknowledgment.

At operation 309, V-AMF 350 and V-SMF 355 may exchange an Nsmf_PDUSession_UpdateSMContext request and response.

At operation 310, V-AMF 350 may transmit H-AMF 345 an Namf_Communication_CreateUEContext response.

At operation 311, H-AMF 345 may transmit to Home NG-RAN 335 a handover command, and at operation 312, Home NG-RAN 335 may forward the RRC handover reconfiguration received in the handover command to UE 330.

At operation 313, UE 330 may transmit to Visited NG-RAN 340 a handover confirmation or handover completion indication. At operation 314, Visited NG-RAN 340 may transmit a handover notification to V-AMF 350. At operation 315, V-AMF 350 may transmit to V-SMF 355 an Nsmf_PDUSession_UpdateSMContext request.

At operation 316, traffic tunnels between V-UPF 360 and H-UPF 370 may be removed if no longer needed.

At operation 317, H-SMF 365 may transmit to V-SMF 355 an Nsmf_PDUSession_Update request configured to remove UE 330 from a multicast MBS session with a new cause.

At operation 318, V-SMF 355 may transmit to UE 330 a trigger for a PDU Session Modification request procedure to remove UE 330 from the multicast MBS session with a new cause, and receive a response.

At operation 318a, after receiving the new rejection cause, UE 330 may not retry to join on the same VPLMN or any other VPLMN.

At operation 319, V-SMF 365 may transmit H-SMF 365 a Nsmf_PDUSession_Update response.

At operation 320, if individual delivery was applied before, H-SMF 365 and/or H-UPF 370 may generate a configuration to stop forwarding MBS multicast data within a PDU session.

At operation 321, V-SMF 355 may transmit to V-AMF 350 an Nsmf_PDUSession_UpdateSMContext response.

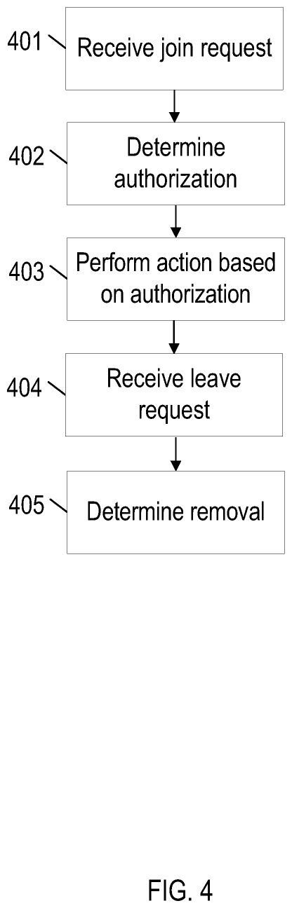

FIG. 4 illustrates an example of a flow diagram of a method 400 that may be performed by a NE, such as NE 1310 illustrated in FIG. 13, according to various example embodiments.

At step 401, the method may include receiving, by a home session management function (H-SMF), from a visited session management function (V-SMF) in a visited public land mobile network (VPLMN), a join request originating from a user equipment (UE) roaming in the VPLMN to join a multicast multicast and broadcast services (MBS) session.

At step 402, the method may further include determining, by the H-SMF, whether the UE is authorized to join the multicast MBS session. The determining may be based upon at least one of a local configuration in a home public land mobile network, information received from an application function during establishment of the multicast MBS session, or user subscription data received from a user data manager.

At step 403, the method may further include performing at least one of, based on determining that the UE is authorized to join the multicast MBS session, transmitting, by the H-SMF, to the V-SMF, an acceptance response configured to establish at least one unicast quality of service (QOS) flow corresponding to multicast QoS flow information received from a home multicast/broadcast session management function (H-MB-SMF), or, based on determining that the UE is not authorized to join the multicast MBS session, transmitting, by the H-SMF, to the V-SMF, a rejection response comprising error cause information indicating that the UE is not authorized to join the multicast MBS session while roaming. The acceptance response may indicate no relation of the at least one unicast QoS flow to the multicast MBS session.

In certain example embodiments, error cause information may indicate that the UE is not authorized to join the multicast MBS session while roaming in the VPLMN. In addition, the join request may be included within an update request.

In some example embodiments, the acceptance response may indicate a relation of the at least one unicast QoS flow to the multicast MBS session, and at least one of unicast QoS flow information, or at least one of an indication that shared MBS traffic delivery shall not be used, an indication individual delivery shall be used, or an indication of a roaming user equipment.

At step 404, the method may further include receiving, by the H-SMF, from the V-SMF, a leave request requesting the UE to leave a multicast MBS session that is managed in the PLMN of the H-SMF, and transmitting, by the H-SMF, to the V-SMF, a request to remove at least one unicast QoS flow corresponding to at least one multicast QoS flow associated with the multicast session. The UE may be authorized to join the multicast MBS session.

At step 405, the method may further include determining, by the H-SMF, that the UE is to be removed from the multicast MBS session, and transmitting, by the H-SMF, to the V-SMF, a request comprising at least one of a request to remove unicast QoS flows associated with the multicast MBS session, a request to indicate to the UE that the UE is removed from the MBS multicast session, or a request to remove the UE from the multicast MBS session.

In various example embodiments, the request to indicate to the UE that the UE is removed from the MBS multicast session or the request to remove the UE from the multicast MBS session indicates that the UE is not authorized to join the MBS session from the VPLMN the UE is roaming into or from any VPLMN.

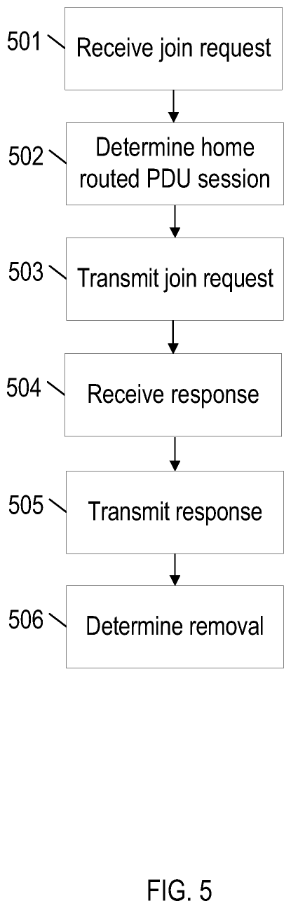

FIG. 5 illustrates an example of a flow diagram of a method 500 that may be performed by a NE, such as NE 1310 illustrated in FIG. 13, according to various example embodiments.

At step 501, the method may include receiving, by a visited session management function (V-SMF), from a UE, a join request requesting that the UE joins a multicast MBS session.

In certain example embodiments, the receiving may further include receiving, by the V-SMF, a response accepting the join request and configured to establish at least one unicast QoS flow, wherein the response indicates for the at least one unicast QoS flow at least one of the following: shared MBS traffic delivery shall not be used, individual delivery shall be used, or that the UE is roaming; and transmitting, by the V-SMF, session management signaling configured to establish at least one unicast QoS flow, wherein the session management signaling indicates for the at least one unicast QoS flow at least one of the following: an indication that shared MBS traffic delivery shall not be used, an indication that individual delivery shall be used, or an indication that the UE is roaming.

At step 502, the method may include determining, by the V-SMF, that the PDU session associated with the join request is a home routed PDU session towards an H-SMF.

At step 503, the method may include transmitting, based on the determination, the join request to the identified H-SMF.

At step 504, the method may further include receiving, by the V-SMF, at least one of an acceptance response to the join request comprising a request to establish at least one unicast QoS flow, or a rejection response.

At step 505, the method may further include transmitting, by the V-SMF, the response to the join request towards the UE.

At step 506, the method may further include determining, by the H-SMF, that the UE is to be removed from the multicast MBS session; and transmitting, by the H-SMF, to the V-SMF, a request comprising at least one of a request to remove unicast QoS flows associated with the multicast MBS session, a request to indicate to the UE that the UE is removed from the MBS multicast session, or a request to remove the UE from the multicast MBS session.

In some example embodiments, the request to indicate to the UE that the UE is removed from the MBS multicast session or the request to remove the UE from the multicast MBS session indicates that the UE is not authorized to join the MBS session from the VPLMN the UE is roaming into or from any VPLMN.

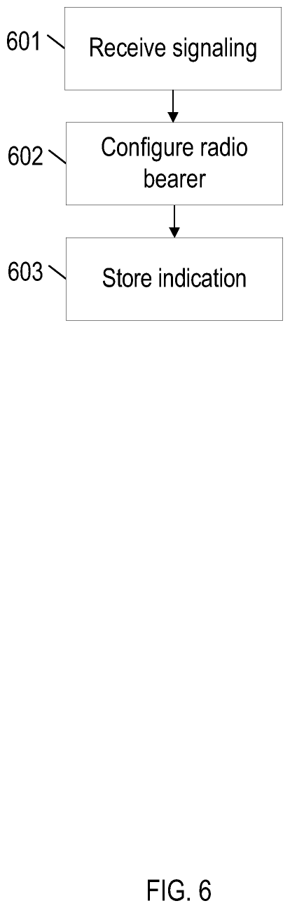

FIG. 6 illustrates an example of a flow diagram of a method 600 that may be performed by a NE, such as NE 1310 illustrated in FIG. 13, according to various example embodiments.

At step 601, the method may include receiving, by a NG RAN node, signaling to establish at least one unicast QoS flow to a UE, wherein the signaling indicates for the at least one unicast QoS flow that it relates to an MBS multicast session and at least one of an indication that shared MBS traffic delivery shall not be used, an indication that individual delivery shall be used, or an indication of a UE.

At step 602, the method may further include configuring at least one radio bearer to transmit the at least one unicast QoS flow to the UE.

At step 603, the method may further include storing the received indication for the at least one unicast QoS flow in the multicast MBS session context.

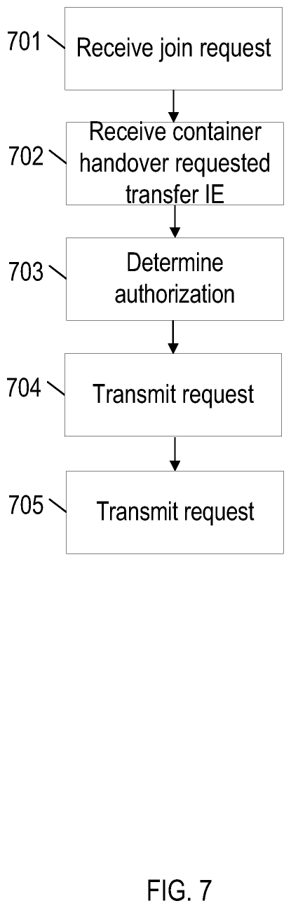

FIG. 7 illustrates an example of a flow diagram of a method 700 that may be performed by a NE, such as NE 1310 illustrated in FIG. 13, according to various example embodiments.

At step 701, the method may include receiving, by a home session management function (H-SMF), a join request requesting a UE to join a multicast MBS session.

At step 702, the method may further include receiving, by the H-SMF, from a V-SMF in a first VPLMN, an N2SM container handover required transfer information element comprising multicast MBS session information of at least one MBS session that the UE has joined.

At step 703, the method may further include determining, by the H-SMF, whether the UE is authorized to continue receiving the multicast MBS session while the UE is roaming in the first VPLMN. In some example embodiments, the determination may be based upon at least one of a local configuration in a home public land mobile network, information received from an application function during establishment of the multicast MBS session, or user subscription data received from a user data manager. In various example embodiments, the determination may be performed if the UE was previously located in the home PLMN or a second VPLMN and is handed over to the first VPLMN.

At step 704, the method may further include, upon determining that the UE is not authorized to continue receiving the multicast MBS service in the VPLMN, transmitting, by the H-SMF, to the V-SMF, a request to indicate to the UE that the UE is removed from the MBS multicast session. In certain example embodiments, the request to indicate to the UE that the UE is removed from the MBS multicast session may include a cause indicating that the UE is not authorized to join the MBS session from the VPLMN it is roaming into or from any VPLMN.

At step 705, the method may further include, if shared delivery was used in the HPLMN before the inter-PLMN mobility upon determining that the UE is authorized to continue receiving the multicast MBS service in the VPLMN, transmitting, by the H-SMF, to the V-SMF, a request to establish at least one unicast QoS flows corresponding to multicast QoS flow information received from an H-MB-SMF. The request configured to establish at least one unicast QoS flow corresponding to multicast QoS flow information received from an H-MB-SMF may not indicate a relation of the unicast QoS flow to the multicast MBS session. The request configured to establish at least one unicast QoS flow corresponding to multicast QoS flow information received from an H-MB-SMF may indicate at least one of a relation of the unicast QoS flow to the multicast MBS session, an indication that shared delivery shall not be used, an indication that individual delivery shall be used, or an indication of a roaming UE.

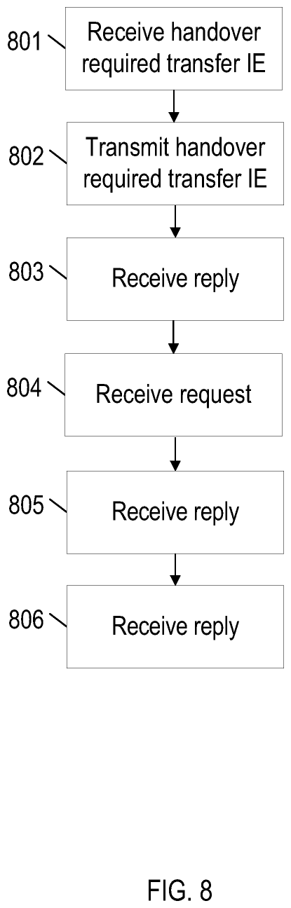

FIG. 8 illustrates an example of a flow diagram of a method 800 that may be performed by a NE, such as NE 1310 illustrated in FIG. 13 according to various example embodiments.

At step 801, the method may include receiving, by a visited session management function (V-SMF), from an AMF, a handover required transfer information element for a home routed PDU session anchored at an H-SMF.

At step 802, the method may further include transmitting the handover required transfer information element to the identified H-SMF.

At step 803, the method may further include receiving, by the V-SMF, in response to transmitting the handover required transfer information element to the H-SMF, a reply message comprising at least one of a request to indicate to the UE that the UE is removed from the MBS multicast session, or a configuration to establish at least one unicast QoS flow.

At step 804, the method may further include receiving, by the V-SMF, from the H-SMF, a request to indicate to the UE that the UE is removed from the MBS multicast session, and transmitting, by the V-SMF, the indication to the UE that the UE is removed from the MBS multicast session. The indication sent to the UE that it is removed from the multicast MBS session may include at least one associated cause if included in the request received from the H-SMF.

At step 805, the method may further include receiving, by the V-SMF the reply message from the H-SMF including a configuration to establish at least one unicast QoS flow, and transmitting, by the V-SMF, session management signaling configured to establish the at least one unicast QoS flow.

At step 806, the method may further include receiving, by the V-SMF the reply message from the H-SMF including a configuration to establish at least one unicast QoS flow and an indication for the at least one unicast QoS flow indicating at least one of the following: an indication that shared MBS traffic delivery shall not be used, an indication that individual delivery shall be used, or an indication that the UE is roaming, and transmitting, by the V-SMF session management signaling configured to establish the at least one unicast QoS flow, wherein the session management signaling indicates for the at least one unicast QoS flow at least one of the following: an indication that shared MBS traffic delivery shall not be used, an indication that individual delivery shall be used, or an indication that the UE is roaming. The reply message from the H-SMF may indicate for the at least one unicast QoS flow that it relates to the MBS session, and the method may further include storing, by the V-SMF that the at least one unicast QoS flow that it relates to the MBS session.

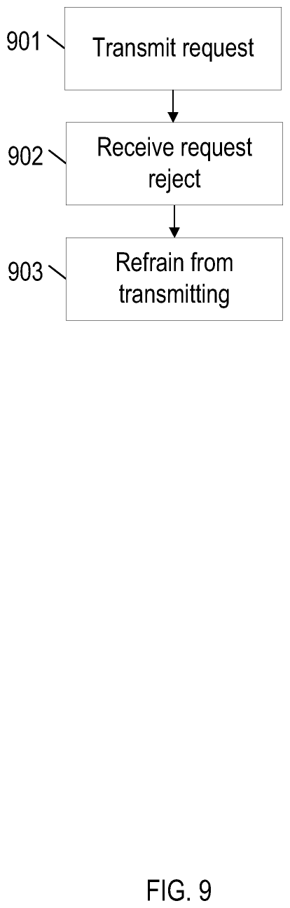

FIG. 9 illustrates an example of a flow diagram of a method 900 that may be performed by a UE, such as UE 1320 illustrated in FIG. 13, according to various example embodiments.

At step 901, the method may include transmitting, by a user equipment roaming in a VPLMN, a request to join a multicast MBS session.

At step 902, the method may further include receiving, by the UE, a join request reject message indication that the UE is not allowed to access the MBS session while roaming.

At step 903, the method may further include refraining to transmit further join request for that MBS session while roaming.

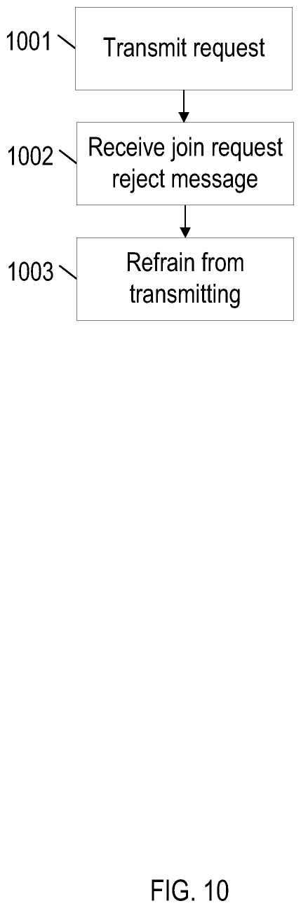

FIG. 10 illustrates an example of a flow diagram of a method 1000 that may be performed by a UE, such as UE 1320 illustrated in FIG. 13, according to various example embodiments.

At step 1001, the method may include transmitting, by a user equipment roaming in a VPLMN, a request to join a multicast MBS session.

At step 1002, the method may further include receiving, by the UE, a join request reject message indication that the UE is not allowed to access the MBS session while roaming in the VPLMN.

At step 1003, the method may further include refraining to transmit further join request for that MBS session while roaming in the VPLMN.

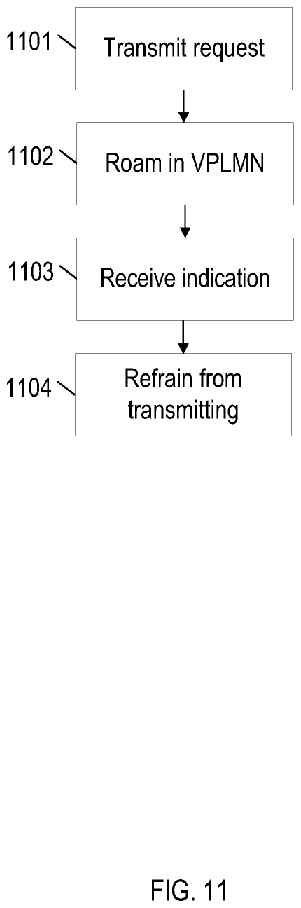

FIG. 11 illustrates an example of a flow diagram of a method 1100 that may be performed by a NE, such as NE 1310 illustrated in FIG. 13, according to various example embodiments.

At step 1101, the method may include transmitting, by a user equipment, a request to join a multicast MBS session.

At step 1102, the method may further include roaming in a VPLMN.

At step 1103, the method may further include receiving, by the UE, an indication that the UE is removed from the MBS session with a cause indicating that the UE is not allowed to access the MBS multicast session while roaming.

At step 1104, the method may further include refraining to transmit further join request for that MBS multicast session while roaming.

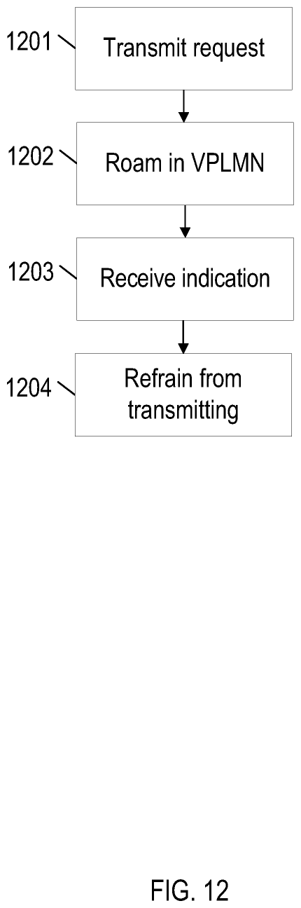

FIG. 12 illustrates an example of a flow diagram of a method 1200 that may be performed by a UE, such as UE 1320 illustrated in FIG. 13, according to various example embodiments.

At step 1201, the method may include transmitting, by a user equipment, a request to join a multicast MBS.

At step 1202, the method may further include roaming in a VPLMN.

At step 1203, the method may further include receiving, by the UE, an indication that the UE is removed from the MBS session with a cause indicating that the UE is not allowed to access the MBS multicast session while roaming in the VPLMN.

At step 1204, the method may further include refraining to transmit further join request for that MBS multicast session while roaming in the VPLMN.

FIG. 13 illustrates an example of a system according to certain example embodiments. In one example embodiment, a system may include multiple devices, such as, for example, NE 1310 and/or UE 1320.

NE 1310 may be one or more of a base station (e.g., 3G UMTS NodeB, 4G LTE Evolved NodeB, or 5G NR Next Generation NodeB), a serving gateway, a server, and/or any other access node or combination thereof.

NE 1310 may further include at least one gNB-centralized unit (CU), which may be associated with at least one gNB-distributed unit (DU). The at least one gNB-CU and the at least one gNB-DU may be in communication via at least one F1 interface, at least one Xn-C interface, and/or at least one NG interface via a 5th generation core (5GC).

UE 1320 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, NE 1310 and/or UE 1320 may be one or more of a citizens broadband radio service device (CBSD).

NE 1310 and/or UE 1320 may include at least one processor, respectively indicated as 1311 and 1321. Processors 1311 and 1321 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 1312 and 1322. The memory may be fixed or removable. The memory may include computer program instructions or computer code contained therein. Memories 1312 and 1322 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 1311 and 1321, memories 1312 and 1322, and any subset thereof, may be configured to provide means corresponding to the various blocks of FIGS. 1A-3D. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 13, transceivers 1313 and 1323 may be provided, and one or more devices may also include at least one antenna, respectively illustrated as 1314 and 1324. The device may have many antennas, such as an array of antennas configured for multiple input multiple output (MIMO) communications, or multiple antennas for multiple RATs. Other configurations of these devices, for example, may be provided. Transceivers 1313 and 1323 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the processes described above (i.e., FIGS. 1A-3D). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1A-3D. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

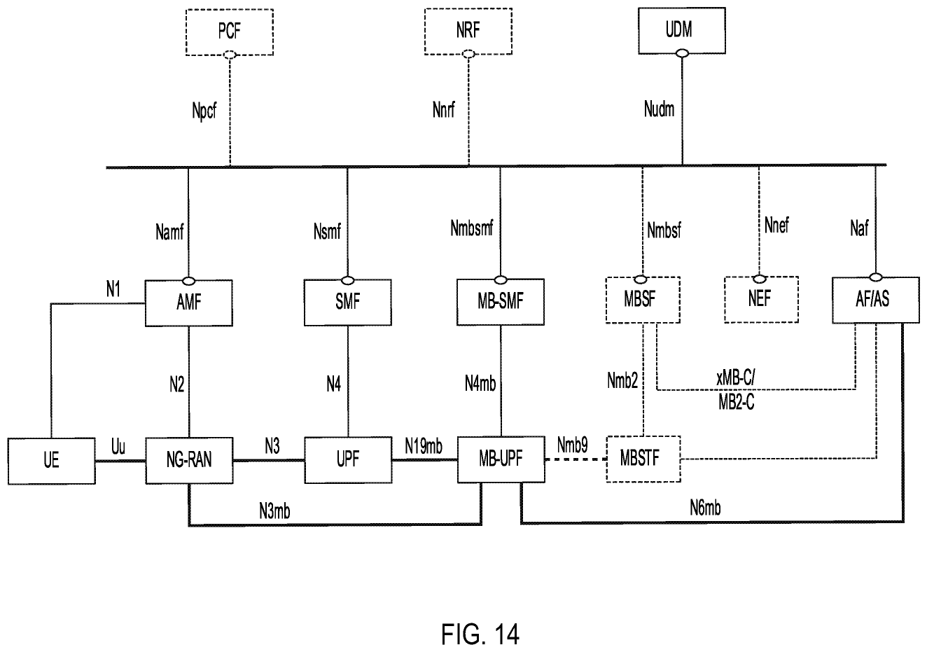

FIG. 14 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 14 may be similar to NE 1310 and UE 1320, respectively. The user plane function (UPF) may provide services such as intra-RAT and inter-RAT mobility, routing and forwarding of data packets, inspection of packets, user plane quality of service (QOS) processing, buffering of downlink packets, and/or triggering of downlink data notifications. The application function (AF) may primarily interface with the core network to facilitate application usage of traffic routing and interact with the policy framework.

According to certain example embodiments, processors 1311 and 1321, and memories 1312 and 1322, may be included in or may form a part of processing circuitry or control circuitry. In addition, in some example embodiments, transceivers 1313 and 1323 may be included in or may form a part of transceiving circuitry.

In some example embodiments, an apparatus (e.g., NE 1310 and/or UE 1320) may include means for performing a method, a process, or any of the variants discussed herein. Examples of the means may include one or more processors, memory, controllers, transmitters, receivers, and/or computer program code for causing the performance of the operations.

In various example embodiments, apparatus 1310 may be controlled by memory 1312 and processor 1311 to receive from a visited session management function (V-SMF) in a visited public land mobile network (VPLMN), a join request originating from a user equipment (UE) roaming in the VPLMN to join a multicast multicast and broadcast services (MBS) session, determine whether the UE is authorized to join the multicast MBS session, and at least one of based on determining that the UE is authorized to join the multicast MBS session, transmitting, to the V-SMF, an acceptance response configured to establish at least one unicast quality of service (QOS) flow corresponding to multicast QoS flow information received from a home multicast/broadcast session management function (H-MB-SMF), or based on determining that the UE is not authorized to join the multicast MBS session, transmitting, to the V-SMF, a rejection response comprising error cause information indicating that the UE is not authorized to join the multicast MBS session while roaming. The determining is based upon at least one of a local configuration in a home public land mobile network, information received from an application function during establishment of the multicast MBS session, or user subscription data received from a user data manager.

Certain example embodiments may be directed to an apparatus that includes means for performing any of the methods described herein including, for example, means for receiving from a visited session management function (V-SMF) in a visited public land mobile network (VPLMN), a join request originating from a user equipment (UE) roaming in the VPLMN to join a multicast multicast and broadcast services (MBS) session, and means for determining whether the UE is authorized to join the multicast MBS session. The determining is based upon at least one of a local configuration in a home public land mobile network, information received from an application function during establishment of the multicast MBS session, or user subscription data received from a user data manager. The apparatus may further include means for performing at least one of based on determining that the UE is authorized to join the multicast MBS session, transmitting, to the V-SMF, an acceptance response configured to establish at least one unicast quality of service (QOS) flow corresponding to multicast QoS flow information received from a home multicast/broadcast session management function (H-MB-SMF), or based on determining that the UE is not authorized to join the multicast MBS session, transmitting, to the V-SMF, a rejection response comprising error cause information indicating that the UE is not authorized to join the multicast MBS session while roaming.

In various example embodiments, apparatus 1310 may be controlled by memory 1312 and processor 1311 to receive, from a UE, a join request requesting that the UE joins a multicast MBS session, determine that a protocol data unit (PDU) session associated with the join request is a home routed PDU session towards a home session management function (H-SMF), transmit, based on the determination, the join request to the identified H-SMF, receive at least one of an acceptance response to the join request comprising a request to establish at least one unicast QoS flow, or a rejection response, and transmit the response to the join request towards the UE.

Certain example embodiments may be directed to an apparatus that includes means for performing any of the methods described herein including, for example, means for receiving, from a UE, a join request requesting that the UE joins a multicast MBS session, means for determining that a protocol data unit (PDU) session associated with the join request is a home routed PDU session towards a home session management function (H-SMF), means for transmitting, based on the determination, the join request to the identified H-SMF, means for receiving at least one of an acceptance response to the join request comprising a request to establish at least one unicast QoS flow, or a rejection response, and means for transmitting the response to the join request towards the UE.

In various example embodiments, apparatus 1310 may be controlled by memory 1312 and processor 1311 to receive signaling to establish at least one unicast QoS flow to a UE, wherein the signaling indicates for the at least one unicast QoS flow that it relates to an MBS multicast session and at least one of an indication that shared MBS traffic delivery shall not be used, an indication that individual delivery shall be used, or an indication of a UE, configure at least one radio bearer to transmit the at least one unicast QoS flow to the UE, and store the received indication for the at least one unicast QoS flow in the multicast MBS session context.

Certain example embodiments may be directed to an apparatus that includes means for performing any of the methods described herein including, for example, means for receiving signaling to establish at least one unicast QoS flow to a UE, wherein the signaling indicates for the at least one unicast QoS flow that it relates to an MBS multicast session and at least one of an indication that shared MBS traffic delivery shall not be used, an indication that individual delivery shall be used, or an indication of a UE, means for configuring at least one radio bearer to transmit the at least one unicast QoS flow to the UE, and means for storing the received indication for the at least one unicast QoS flow in the multicast MBS session context.

In various example embodiments, apparatus 1310 may be controlled by memory 1312 and processor 1311 to receive a join request requesting a UE to join a multicast MBS session, receive from a V-SMF in a first VPLMN, an N2SM container handover required transfer information element comprising multicast MBS session information of at least one MBS session that the UE has joined, and determine whether the UE is authorized to continue receiving the multicast MBS session while the UE is roaming in the first VPLMN. The determination is based upon at least one of a local configuration in a home public land mobile network, information received from an application function during establishment of the multicast MBS session, or user subscription data received from a user data manager.

Certain example embodiments may be directed to an apparatus that includes means for performing any of the methods described herein including, for example, means for receiving a join request requesting a UE to join a multicast MBS session, means for receiving from a V-SMF in a first VPLMN, an N2SM container handover required transfer information element comprising multicast MBS session information of at least one MBS session that the UE has joined, and means for determining whether the UE is authorized to continue receiving the multicast MBS session while the UE is roaming in the first VPLMN. The determination is based upon at least one of a local configuration in a home public land mobile network, information received from an application function during establishment of the multicast MBS session, or user subscription data received from a user data mana.

In various example embodiments, apparatus 1310 may be controlled by memory 1312 and processor 1311 to receive, from an AMF, a handover required transfer information element for a home routed PDU session anchored at an H-SMF, transmit the handover required transfer information element to the identified H-SMF, and receive in response to transmitting the handover required transfer information element to the H-SMF, a reply message comprising at least one of the following: a request to indicate to the UE that the UE is removed from the MBS multicast session, or a configuration to establish at least one unicast QoS flow.

Certain example embodiments may be directed to an apparatus that includes means for performing any of the methods described herein including, for example, means for receiving, from an AMF, a handover required transfer information element for a home routed PDU session anchored at an H-SMF, means for transmitting the handover required transfer information element to the identified H-SMF, and means for receiving in response to transmitting the handover required transfer information element to the H-SMF, a reply message comprising at least one of the following: a request to indicate to the UE that the UE is removed from the MBS multicast session, or a configuration to establish at least one unicast QoS flow.

In various example embodiments, apparatus 1320 may be controlled by memory 1322 and processor 1321 to transmit a request to join a multicast MBS session, receive a join request reject message indication that the apparatus is not allowed to access the MBS session while roaming, and refrain to transmit further join request for that MBS session while roaming.

Certain example embodiments may be directed to an apparatus that includes means for performing any of the methods described herein including, for example, means for transmitting a request to join a multicast MBS session, means for receiving a join request reject message indication that the apparatus is not allowed to access the MBS session while roaming, and means for refraining to transmit further join request for that MBS session while roaming.

In various example embodiments, apparatus 1320 may be controlled by memory 1322 and processor 1321 to transmit a request to join a multicast MBS session, receive a join request reject message indication that the apparatus is not allowed to access the MBS session while roaming in the VPLMN, and refrain to transmit further join request for that MBS session while roaming in the VPLMN.

Certain example embodiments may be directed to an apparatus that includes means for performing any of the methods described herein including, for example, means for transmitting a request to join a multicast MBS session, means for receiving a join request reject message indication that the apparatus is not allowed to access the MBS session while roaming in the VPLMN, and means for refraining to transmit further join request for that MBS session while roaming in the VPLMN.

In various example embodiments, apparatus 1320 may be controlled by memory 1322 and processor 1321 to transmit a request to join a multicast MBS session, roam in a VPLMN, receive an indication that the apparatus is removed from the MBS session with a cause indicating that the apparatus is not allowed to access the MBS multicast session while roaming in the VPLMN, and refrain to transmit further join request for that MBS multicast session while roaming in the VPLMN.

Certain example embodiments may be directed to an apparatus that includes means for performing any of the methods described herein including, for example, means for transmitting a request to join a multicast MBS session, means for roaming in a VPLMN. The apparatus may further include means for receiving an indication that the apparatus is removed from the MBS session with a cause indicating that the apparatus is not allowed to access the MBS multicast session while roaming in the VPLMN, and means for refraining to transmit further join request for that MBS multicast session while roaming in the VPLMN.

In various example embodiments, apparatus 1320 may be controlled by memory 1322 and processor 1321 to transmit a request to join a multicast MBS session, roam in a VPLMN, receive an indication that the apparatus is removed from the MBS session with a cause indicating that the apparatus is not allowed to access the MBS multicast session while roaming in the VPLMN, and refrain to transmit further join request for that MBS multicast session while roaming.

Certain example embodiments may be directed to an apparatus that includes means for performing any of the methods described herein including, for example, means for transmitting a request to join a multicast MBS session, means for roaming in a VPLMN. The apparatus may further include means for receiving an indication that the apparatus is removed from the MBS session with a cause indicating that the apparatus is not allowed to access the MBS multicast session while roaming in the VPLMN, and means for refraining to transmit further join request for that MBS multicast session while roaming.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### Partial Glossary

3GPP 3^{rd} Generation Partnership Project
5G 5^{th} Generation
5GC 5^{th} Generation Core
6G 6^{th} Generation
ACK Acknowledgement
AF Application Function
AMF Access and Mobility Management Function
ASIC Application Specific Integrated Circuit
CBSD Citizens Broadband Radio Service Device
CPU Central Processing Unit
CRC Cyclic Redundancy Check
CU Centralized Unit
DL Downlink
DU Distributed Unit
eMBB Enhanced Mobile Broadband
eNB Evolved Node B
gNB Next Generation Node B
GPS Global Positioning System
HDD Hard Disk Drive
H-MB-SMF Home Multicast/Broadcast Session Management Function
HPLMN Home Public Land Mobile Network
H-UPF Home User Plane Function
IE Information Element
IoT Internet of Things
LTE Long-Term Evolution
LTE-A Long-Term Evolution Advanced
MBS Multicast and Broadcast Systems
MEMS Micro Electrical Mechanical System
MIMO Multiple Input Multiple Output
mMTC Massive Machine Type Communication
NE Network Entity
NG Next Generation
NGAP Next Generation Application Protocol
NG-eNB Next Generation Evolved Node B
NG-RAN Next Generation Radio Access Network
NR New Radio
PDA Personal Digital Assistance
PDU Protocol Data Unit
QoS Quality of Service
RAM Random Access Memory
RAN Radio Access Network
RAT Radio Access Technology
RF Radio Frequency
ROM Read-Only Memory
SMF Session Management Function
UDM Unified Data Manager
UE User Equipment
UMTS Universal Mobile Telecommunications System
UPF User Plane Function
URLLC Ultra-Reliable and Low-Latency Communication
UTRAN Universal Mobile Telecommunications System Terrestrial Radio Access Network
WLAN Wireless Local Area Network

We claim:

1. A method comprising:
receiving, by a home session management function (H-SMF), from a visited session management function (V-SMF) in a visited public land mobile network (VPLMN), a join request originating from a user equipment (UE) roaming in the VPLMN to join a multicast multicast and broadcast services (MBS) session; and
determining, by the H-SMF, whether the UE is authorized to join the multicast MBS session,
wherein the determining is based upon at least one of the following:
a local configuration in a home public land mobile network,
information received from an application function during establishment of the multicast MBS session, or
user subscription data received from a user data manager, and performing at least one of:
based on determining that the UE is authorized to join the multicast MBS session, transmitting, by the H-SMF, to the V-SMF, an acceptance response configured to establish at least one unicast quality of service (QOS) flow corresponding to multicast QoS flow information received from a home multicast/broadcast session management function (H-MB-SMF), or
based on determining that the UE is not authorized to join the multicast MBS session, transmitting, by the H-SMF, to the V-SMF, a rejection response comprising error cause information indicating that the UE is not authorized to join the multicast MBS session while roaming.

2. The method of claim 1, wherein error cause information indicates that the UE is not authorized to join the multicast MBS session while roaming in the VPLMN.

3. The method of claim 1, wherein the join request is comprised within an update request.

4. The method of claim 1, wherein the acceptance response indicates no relation of the at least one unicast QoS flow to the multicast MBS session.

5. The method of claim 1, wherein the acceptance response indicates a relation of the at least one unicast QoS flow to the multicast MBS session, and at least one of the following:
unicast QoS flow information, or at least one of the following:
an indication that shared MBS traffic delivery shall not be used,
an indication individual delivery shall be used, or
an indication of a roaming user equipment.

6. The method of claim 1, wherein the UE is authorized to join the multicast MBS session, the method further comprising:
receiving, by the H-SMF, from the V-SMF, a leave request requesting the UE to leave a multicast MBS session that is managed in the PLMN of the H-SMF; and
transmitting, by the H-SMF, to the V-SMF, a request to remove at least one unicast QoS flow corresponding to at least one multicast QoS flow associated with the multicast session.

7. The method of claim 1, further comprising:
determining, by the H-SMF, that the UE is to be removed from the multicast MBS session; and
transmitting, by the H-SMF, to the V-SMF, a request comprising at least one of the following:
a request to remove unicast QoS flows associated with the multicast MBS session,
a request to indicate to the UE that the UE is removed from the MBS multicast session, or
a request to remove the UE from the multicast MBS session.

8. The method of claim 7, wherein the request to indicate to the UE that the UE is removed from the MBS multicast session or the request to remove the UE from the multicast MBS session indicates that the UE is not authorized to join the MBS session from the VPLMN the UE is roaming into or from any VPLMN.

9. A method comprising:
receiving, by a visited session management function (V-SMF), from a UE, a join request requesting that the UE joins a multicast MBS session;
determining, by the V-SMF, that the PDU session associated with the join request is a home routed PDU session towards an H-SMF;
transmitting, based on the determining, the join request to the identified H-SMF;
receiving, by the V-SMF, at least one of the following:
an acceptance response to the join request comprising a request to establish at least one unicast QoS flow, or
a rejection response; and
transmitting, by the V-SMF, the at least one of the acceptance response to the join request or the rejection response towards the UE.

10. The method of claim 9, wherein the receiving further comprises:
receiving, by the V-SMF, a response accepting the join request and configured to establish at least one unicast QoS flow, wherein the response indicates for the at least one unicast QoS flow at least one of the following: shared MBS traffic delivery shall not be used, individual delivery shall be used, or that the UE is roaming; and
transmitting, by the V-SMF, session management signaling configured to establish at least one unicast QoS flow, wherein the session management signaling indicates for the at least one unicast QoS flow at least one of the following: an indication that shared MBS traffic delivery shall not be used, an indication that individual delivery shall be used, or an indication that the UE is roaming.

11. The method of claim 10, wherein the response indicates for the at least one unicast QoS flow that the at least one unicast flow relates to the MBS session, and further comprising:
storing, by the V-SMF, information that indicates the at least one unicast QoS flow relates to the MBS session.

12. The method of claim 9, further comprising:
receiving, by the V-SMF, from the UE, a leave request requesting that the UE leaves the multicast MBS session; and
transmitting, by the V-SMF, the leave request to the H-SMF.

13. The method of claim 9, further comprising:
receiving, by the V-SMF, from the H-SMF, a request to indicate to the UE that the UE is removed from the MBS multicast session; and
transmitting, by the V-SMF, to the UE, an indication that the UE is removed from the MBS multicast session.

14. The method of claim 13, further comprising:
transmitting, by the V-SMF, to the UE, at least one associated cause received in the request from the H-SMF.

15. The method of claim 9, further comprising:
receiving, by the V-SMF, from the H-SMF, a request to trigger removal of the UE from the multicast MBS session;
determining based on stored information unicast QoS flows related to the multicast MBS session;
transmitting a request to remove the unicast QoS flows associated with the multicast MBS session from the PDU session; and
transmitting a request to the UE to indicate that the UE is removed from the MBS multicast session.

16. The method of claim 9, further comprising:
transmitting, by the V-SMF, to the UE, at least one associated cause received in the request from the H-SMF.

17. A method comprising:
receiving, by a home session management function (H-SMF), a join request requesting a UE to join a multicast MBS session;
receiving, by the H-SMF, from a V-SMF in a first VPLMN, an N2SM container handover required transfer information element comprising multicast MBS session information of at least one MBS session that the UE has joined; and
determining, by the H-SMF, whether the UE is authorized to continue receiving the multicast MBS session while the UE is roaming in the first VPLMN,
wherein the determining is based upon at least one of:
a local configuration in a home public land mobile network,
information received from an application function during establishment of the multicast MBS session, or
user subscription data received from a user data manager.

18. The method of claim 17, wherein the determining is performed if the UE was previously located in the home PLMN or a second VPLMN and is handed over to the first VPLMN.

19. The method of claim 17, further comprising:
upon determining that the UE is not authorized to continue receiving the multicast MBS service in the VPLMN, transmitting, by the H-SMF, to the V-SMF, a request to indicate to the UE that the UE is removed from the MBS multicast session.

20. The method of claim 19, wherein the request to indicate to the UE that the UE is removed from the MBS multicast session comprises a cause indicating that the UE is not authorized to join the MBS session from the VPLMN it is roaming into or from any VPLMN.
